(19) United States
(12) Patent Application Publication
(10) Pub. No.: US 2025/0367885 A1
(43) Pub. Date: Dec. 4, 2025

(54) METHOD FOR PRODUCING THREE-DIMENSIONAL SHAPED OBJECT AND DATA GENERATION METHOD

(71) Applicant: SEIKO EPSON CORPORATION, Tokyo (JP)

(72) Inventor: Shigeru YAMAZAKI, SHIOJIRI-SHI (JP)

(21) Appl. No.: 19/223,652

(22) Filed: May 30, 2025

(30) Foreign Application Priority Data
May 31, 2024 (JP) 2024-088537

(51) Int. Cl. B29C 64/393; B29C 64/118; B33Y 10/00; B33Y 50/02

(52) U.S. Cl. CPC B29C 64/393; B29C 64/118; B33Y 10/00; B33Y 50/02

(57) ABSTRACT

A method for producing a three-dimensional shaped object includes a first acquisition step for acquiring first shape data representing a three-dimensional shape of the three-dimensional shaped object and first shaping data that is generated on the basis of the first shape data and that is for shaping the three-dimensional shaped object; a first display step for displaying the three-dimensional shaped object on a display section based on the first shape data; a determination step for determining a target region of the three-dimensional shaped object that is displayed on the display section based on a designation region that designates a range in three-dimensional space; a second acquisition step for selecting data of a portion corresponding to the target region in the first shaping data and acquiring second shaping data; and a shaping step, based on the second shaping data, for performing three-dimensional shaping to stack layers by discharging shaping material from a discharge section toward a stage.

The present application is based on, and claims priority from JP Application Serial Number 2024-088537, filed May 31, 2024, the disclosure of which is hereby incorporated by reference herein in its entirety.

### BACKGROUND

### 1. Technical Field

The present disclosure relates to a method of producing a three-dimensional shaped object and a data generation method.

### 2. Related Art

Regarding a method for producing a three-dimensional shaped object, JP-A-2022-71244 describes that after a raft layer is formed on a stage, a 3D solid model is printed on the raft layer.

When test shaping of the three-dimensional shaped object is performed to check the actual shaping state of a part of the three-dimensional shaped object, parts other than this that need to be checked are also shaped. Therefore, there may be a problem that the shaping time becomes long and that the amount of shaping material used becomes large. These problems are particularly conspicuous when performing test shaping of a large-sized three-dimensional shaped object.

### SUMMARY

According to a first aspect of the present disclosure, a method for producing a three-dimensional shaped object is provided. This method for producing the three-dimensional shaped object includes a first acquisition step for acquiring first shape data representing a three-dimensional shape of the three-dimensional shaped object and first shaping data that is generated based on the first shape data and that is for shaping the three-dimensional shaped object; a first display step for displaying the three-dimensional shaped object on a display section based on the first shape data; a determination step for determining a target region of the three-dimensional shaped object that was displayed on the display section based on a designation region that designates a range in three-dimensional space; a second acquisition step for selecting data of a portion corresponding to the target region in the first shaping data and acquiring second shaping data; and a shaping step, based on the second shaping data, for performing three-dimensional shaping to stack layers by discharging shaping material from a discharge section toward a stage.

According to a second aspect of the present disclosure, a data generation method for generating shaping data for producing a three-dimensional shaped object by discharging a shaping material from a discharge section toward a stage to stack layers is provided. This data generation method includes acquiring first shape data representing a three-dimensional shape of a three-dimensional shaped object and first shaping data that is generated based on the first shape data and that is for shaping the three-dimensional shaped object; displaying the three-dimensional shaped object on the display section based on the first shape data; determining a target region of the three-dimensional shaped object displayed on the display section based on a designation region that designates a range in a three-dimensional space; and selecting data of a portion corresponding to the target region from the first shaping data to generate second shaping data.

### BRIEF DESCRIPTION OF THE DRAWINGS

FIG. 1 is an explanatory diagram showing a schematic configuration of a three-dimensional shaping system.

FIG. 2 is a perspective diagram showing a schematic configuration of a lower surface side of a flat screw.

FIG. 3 is a schematic plan diagram showing the upper surface side of a barrel.

FIG. 4 is an explanatory diagram schematically showing how a three-dimensional shaping device shapes a shaped object.

FIG. 5 is an explanatory diagram showing a schematic configuration of an information process device.

FIG. 6 is a flowchart of a shaping process in the first embodiment.

FIG. 7 is an explanatory diagram showing an example of a first shaped object represented by first shape data.

FIG. 8 is an explanatory diagram showing an example in which the first shape data is read into slicer software.

FIG. 9 is an explanatory diagram showing a first example of a determination step in the first embodiment.

FIG. 10 is an explanatory diagram showing a second example of the determination step in the first embodiment.

FIG. 11 is an explanatory diagram showing a third example of the determination step in the first embodiment.

FIG. 12 is a first schematic diagram showing generation of shaping data.

FIG. 13 is a second schematic diagram showing generation of the shaping data.

FIG. 14 is an explanatory diagram showing an example of the determination step in a second embodiment.

FIG. 15 is an explanatory diagram showing an example of the determination step in a third embodiment.

FIG. 16 is a flowchart of a shaping process in a fourth embodiment.

FIG. 17 is an explanatory diagram showing an example of a second shape acquisition step and a second display step.

FIG. 18 is a flowchart of the shaping process in a fifth embodiment.

FIG. 19 is an explanatory diagram showing an example of a third shape acquisition step and the second display step.

FIG. 20 is an explanatory diagram showing a first example of the second acquisition step in a sixth embodiment.

FIG. 21 is an explanatory diagram showing a second example of the second acquisition step in the sixth embodiment.

### DESCRIPTION OF EMBODIMENTS

### a. First Embodiment

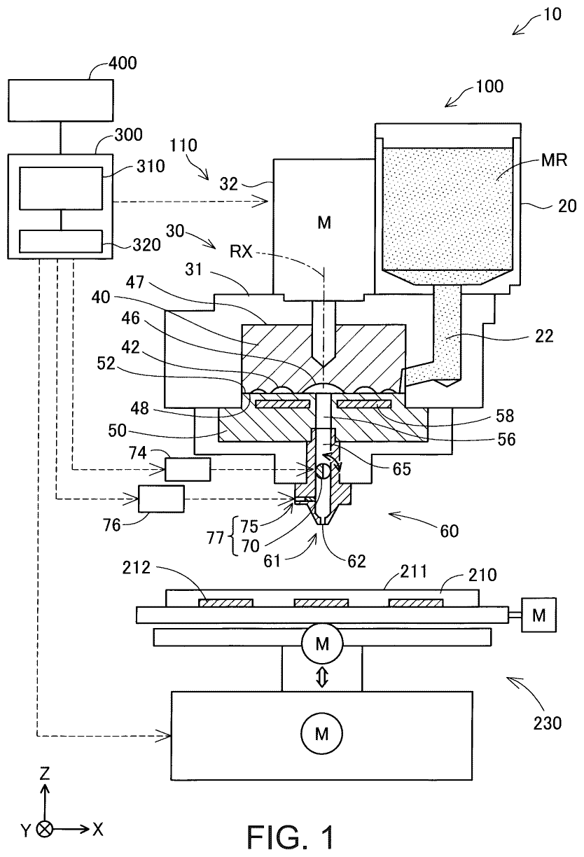

FIG. 1 is an explanatory diagram showing a schematic configuration of a three-dimensional shaping system 10 according to a first embodiment. FIG. 1 shows arrows indicating X, Y, and Z directions, which are orthogonal to each other. The X direction and the Y direction are directions parallel to a horizontal plane, and the Z direction is a direction along a vertically upward direction. The arrows indicating the X, Y, and Z directions are appropriately shown in other figures so that the illustrated directions correspond to those in FIG. 1. In the following description, when specifying the directional orientation, the direction indicated by the arrow in each figure is “+” and the opposite direction from it is “−”, and positive and negative signs are used together in the directional notation. Hereinafter, a +Z direction is also referred to as “upper”, and a −Z direction is also referred to as “lower”.

The three-dimensional shaping system 10 is equipped with a three-dimensional shaping device 100 and an information process device 400. The three-dimensional shaping device 100 of the present embodiment is a device that shapes a shaped object using a material push out method, the three-dimensional shaping device 100 is equipped with a control section 300 that controls each section of the three-dimensional shaping device 100. The control section 300 and the information process device 400 are connected so that they can communicate with each other.

The three-dimensional shaping device 100 is equipped with a shaping section 110, which generates and discharges shaping material, a stage 210, which serves as a base member PM of a shaped object, and a movement mechanism 230, which controls the discharge position where the shaping material is discharged.

The shaping section 110 discharges shaping material, which is plasticized from solid state material, onto the stage 210 under the control of the control section 300. The shaping section 110 has a material supply section 20, which is a supply source of raw material before it is converted into shaping material, a plasticizing section 30, which converts the raw material into shaping material, and a discharge section 60, which discharges the shaping material.

The material supply section 20 supplies the raw material MR to the plasticizing section 30. The material supply section 20 is, for example, composed of a hopper that holds the raw material MR. The material supply section 20 is connected to the plasticizing section 30 through a communication path 22. The raw material MR is supplied to the material supply section 20 in the form of powder or pellets. Thermoplastic resins such as acrylonitrile butadiene styrene resin (ABS), polypropylene resin (PP), polyethylene resin (PE), or polyacetal resin (POM) are used as the raw material MR.

The plasticizing section 30 plasticizes the raw material MR supplied from the material supply section 20 to generate a paste-like shaping material having fluidity, and leads it to the discharge section 60. In the present embodiment, “plasticization” means a concept including melting, and means a change from a solid state to a fluid state. Specifically, in the case of a material in which glass transition occurs, plasticization means that the temperature of the material is made to be equal to or greater than the glass transition point. For material that does not undergo glass transition, “plasticization” means that the temperature of the material is raised to or above the melting point.

The plasticizing section 30 has a screw case 31, a drive motor 32, a flat screw 40, and a barrel 50. The flat screw 40 is also referred to as a rotor or scroll. The barrel 50 is also referred to as a screw facing section.

The flat screw 40 is housed in the screw case 31. An upper surface 47 of the flat screw 40 is connected to the drive motor 32, and the flat screw 40 is rotated in the screw case 31 by a rotational drive force generated by the drive motor 32. The drive motor 32 is driven under the control of the control section 300. The flat screw 40 may be driven by the drive motor 32 via a reduction gear.

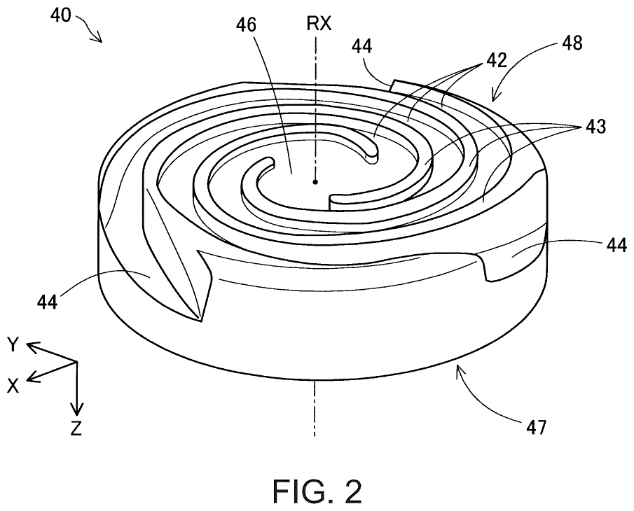

FIG. 2 is a perspective diagram showing a schematic configuration of a lower surface 48 side of the flat screw 40. The flat screw 40 shown in FIG. 2 is illustrated with a positional relationship between the upper surface 47 and the lower surface 48 shown in FIG. 1 reversed in the vertical direction for facilitating understanding of the technology. The flat screw 40 has a substantially cylindrical shape whose length in an axial direction, which is a direction along its central axis, is smaller than a length in a direction perpendicular to the axial direction. The flat screw 40 is arranged so that a rotation axis RX, which serves as a rotation center of the flat screw 40, is parallel to the Z direction.

A whorl shape groove section 42 is formed on a lower surface 48 of the flat screw 40, which is a surface intersecting the rotation axis RX. The communication path 22 of the material supply section 20 described above communicates with the groove section 42 from the side surface of the flat screw 40. In the present embodiment, three groove sections 42, which are spaced apart, are formed by the ridge portions 43. The number of the groove sections 42 is not limited to three, and may be one or two or more. The groove sections 42 are not limited to a whorl shape, may be a spiral shape or an involute curve shape, and may extend so as to draw an arc from the center portion 46 to the outer periphery.

As shown in FIG. 1, the lower surface 48 of the flat screw 40 faces the upper surface 52 of the barrel 50, and a space is formed between the groove section 42 of the lower surface 48 of the flat screw 40 and the upper surface 52 of the barrel 50. The raw material MR is supplied into this space between the flat screw 40 and the barrel 50 from the material supply section 20 through the material inflow port 44 shown in FIG. 2.

The barrel heater 58 is embedded in the barrel 50 to heat the raw material MR supplied into the groove sections 42 of the rotating flat screw 40. A communication hole 56 is provided at the center of the barrel 50.

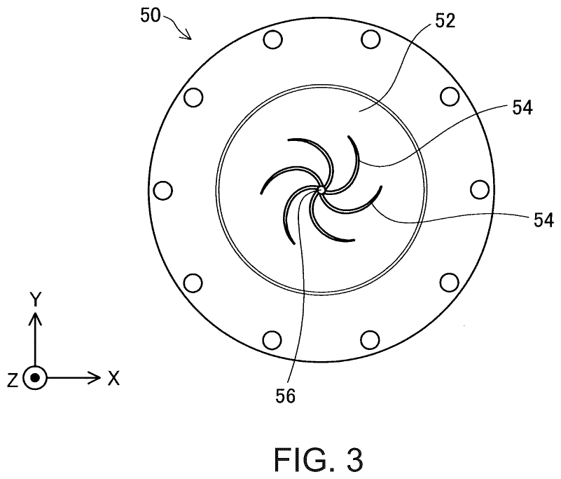

FIG. 3 is a schematic plan diagram showing the upper surface 52 side of the barrel 50. The upper surface 52 of the barrel 50 has a plurality of guide grooves 54 that are connected to the communication hole 56 and that extend in a whorl shape from the communication hole 56 toward the outer periphery. Note that one end portion of the guide grooves 54 may not be connected to the communication hole 56. It is also possible to omit the guide grooves 54.

The raw material MR supplied into the groove sections 42 of the flat screw 40 flows along the groove sections 42 by the rotation of the flat screw 40 while being plasticized in the groove sections 42, and is guided to the center portion 46 of the flat screw 40 as the shaping material. The paste-like shaping material exhibiting fluidity that has flowed into the center portion 46 is supplied to the discharge section 60 through the communication hole 56 provided in the center of the barrel 50. Note that in the shaping material, not all types of substances that constitute the shaping material need to be plasticized. The shaping material only needs to become in a state where it has fluidity as a whole by plasticizing at least some of the types of substances that constitute the shaping material.

The discharge section 60 in FIG. 1 has a nozzle 61 that discharges the shaping material, a flow path 65 for the shaping material that is provided between the flat screw 40 and the nozzle opening 62, and a discharge control section 77 that controls the discharge of the shaping material.

The nozzle 61 is connected to the communication hole 56 of the barrel 50 through the flow path 65. The nozzle 61 discharges the shaping material generated in the plasticizing section 30 from the nozzle opening 62, which is a tip end portion of the nozzle 61, toward the stage 210.

The discharge control section 77 has a discharge adjustment section 70 that opens and closes the flow path 65, and a suction section 75 that sucks and temporarily stores the shaping material.

The discharge adjustment section 70 is provided in the flow path 65, and changes the opening degree of the flow path 65 by pivoting in the flow path 65. In the present embodiment, the discharge adjustment section 70 is composed of a valve. The discharge adjustment section 70 is driven by a first drive section 74 under the control of the control section 300. For example, the first drive section 74 is composed of a stepping motor. The control section 300 can adjust the flow rate of the shaping material flowing from the plasticizing section 30 to the nozzle 61, that is, the discharge amount of the shaping material discharged from the nozzle 61 by controlling the pivoting angle of the discharge adjustment section 70 using the first drive section 74. The discharge adjustment section 70 can adjust the discharge amount of the shaping material and can also control ON and OFF of the outflow of the shaping material.

The suction section 75 is connected between the discharge adjustment section 70 and the nozzle opening 62 in the flow path 65. When stopping the discharge of the shaping material from the nozzle 61, the suction section 75 temporarily sucks the shaping material from the flow path 65. By this, it can suppress a tail-dragging phenomenon in which the shaping material drips from the nozzle opening 62 in a string-like manner. In the present embodiment, the suction section 75 is composed of a plunger. The suction section 75 is driven by a second drive section 76 under the control of the control section 300. For example, the second drive section 76 is composed of a stepping motor and a rack and pinion mechanism that converts rotational force of the stepping motor into translation movement of the plunger.

The stage 210 is arranged at a position facing the nozzle opening 62 of the nozzle 61. In the first embodiment, a shaping surface 211 of the stage 210, which faces the nozzle opening 62 of the nozzle 61, is arranged to be parallel to the X and Y directions, that is, the horizontal direction. The stage 210 has a stage heater 212 that suppresses rapid cooling of the shaping material discharged onto the stage 210. The stage heater 212 is controlled by the control section 300.

The movement mechanism 230 changes the relative position between the stage 210 and the nozzle 61 under the control of the control section 300. In the present embodiment, the nozzle 61 is fixed in position, and movement mechanism 230 moves stage 210. The movement mechanism 230 is composed of a three-axis positioner that moves the stage 210 in three-axis directions of X, Y, and Z directions by drive force of three motors. In this specification, unless otherwise specified, a movement of the nozzle 61 means to relatively move the nozzle 61 or the discharge section 60 with respect to the stage 210.

Note that in other embodiments, instead of the configuration where the stage 210 is moved by the movement mechanism 230, a configuration where the movement mechanism 230 move the nozzle 61 with respect to the stage 210 while the position of the stage 210 is fixed may be adopted. A configuration where the movement mechanism 230 moves the stage 210 in the Z direction and moves the nozzle 61 in the X and Y directions or a configuration where the movement mechanism 230 moves the stage 210 in the X and Y directions and moves the nozzle 61 in the Z direction, may be adopted. Even in these configurations, the movement mechanism 230 can change the relative positional relationship between the nozzle 61 and the stage 210.

Although only one shaping section 110 is illustrated in FIG. 1, the three-dimensional shaping device 100 may be equipped with a plurality of shaping sections 110. By providing a plurality of shaping sections 110, different types of shaping materials can be discharged from each shaping section 110. For example, the main body of the shaped object can be shaped using one type of shaping material, while the support structure that supports the shaped object can be shaped using a different type of shaping material.

The control section 300 is a control device that controls the operation of the entire three-dimensional shaping device 100. The control section 300 is composed of a computer that has one or more processors 310, a storage device 320 that consists of a main storage device and an auxiliary storage device, and an input and output interface that performs input and output of signals to and from the outside. The processor 310, by executing the program stored in the storage device 320, controls the shaping section 110 and the movement mechanism 230 to shape the shaped object on the stage 210 according to the shaping data obtained from the information process device 400. Note that the control section 300 may be realized by a combination of circuits instead of being composed of a computer.

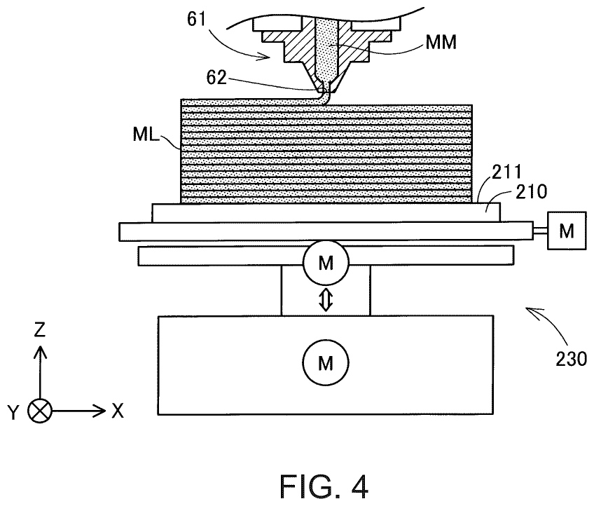

FIG. 4 is an explanatory diagram schematically showing how the three-dimensional shaping device 100 shapes the shaped object. As described above, in the three-dimensional shaping device 100, the shaping material MM is generated by plasticizing the solid raw material MR. The control section 300, while maintaining the distance between the shaping surface 211 of the stage 210 and the nozzle 61, discharges shaping material MM from the nozzle 61 in the direction along the shaping surface 211 of the stage 210 while changing the position of the nozzle 61 with respect to the stage 210. The shaping material MM discharged from the nozzle 61 is continuously deposited in the movement direction of the nozzle 61.

The control section 300 repeats the movement of the nozzle 61 to form layers ML. After forming one layer ML, the control section 300 relatively moves the position of the nozzle 61 with respect to the stage 210 in the Z direction, which is a layer stacking direction of the layer ML. Then, by stacking another layer ML on the top of the previously formed layer ML, a shaped object is formed.

When the nozzle 61 moves in the Z direction after completing a single layer of layer ML, or when there are multiple independent shaping regions in a single layer, the control section 300 may temporarily suspend discharge of the shaping material from the nozzle 61. In this case, the discharge adjustment section 70 closes the flow path 65 to stop the discharge of shaping material MM from the nozzle opening 62, and the suction section 75 temporarily sucks the shaping material inside the nozzle 61. After changing the position of the nozzle 61, the control section 300 resumes the deposition of shaping material MM from the changed position of the nozzle 61 by opening the flow path 65 by the discharge adjustment section 70 while discharging the shaping material in the suction section 75.

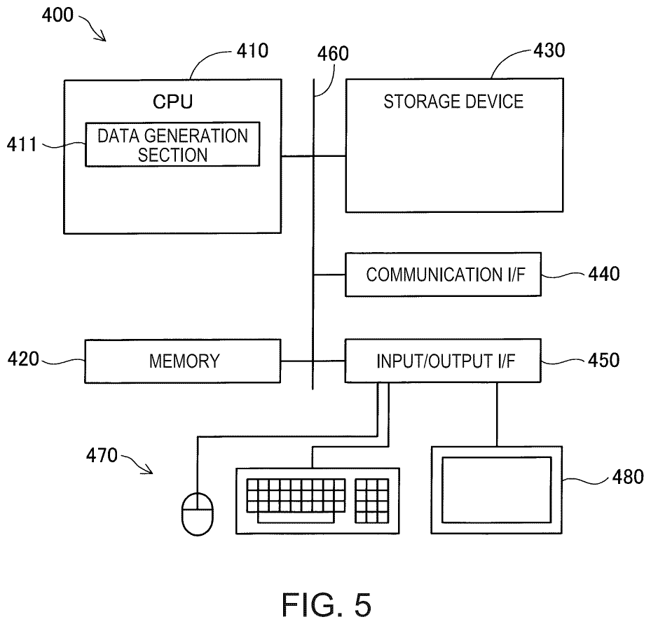

FIG. 5 is an explanatory diagram showing a schematic configuration of the information process device 400. The information process device 400 is composed of a computer in which a CPU 410, a memory 420, a storage device 430, a communication interface 440, and an input and output interface 450 are interconnected by a bus 460. An input device 470, such as a keyboard and a mouse, and a display section 480, such as a liquid crystal display, are connected to the input and output interface 450. The information process device 400 is connected to the control section 300 of the three-dimensional shaping device 100 via the communication interface 440.

The CPU 410 functions as a data generation section 411 by executing a program stored in the storage device 430. The data generation section 411 generates shaping data that is used to shape a three-dimensional shaped object by the three-dimensional shaping device 100. The shaping data includes, for each layer obtained by slicing a shape of the model into a plurality of layers, path information representing a movement path of the nozzle 61 and discharge amount information representing a discharge amount of the shaping material in each movement path.

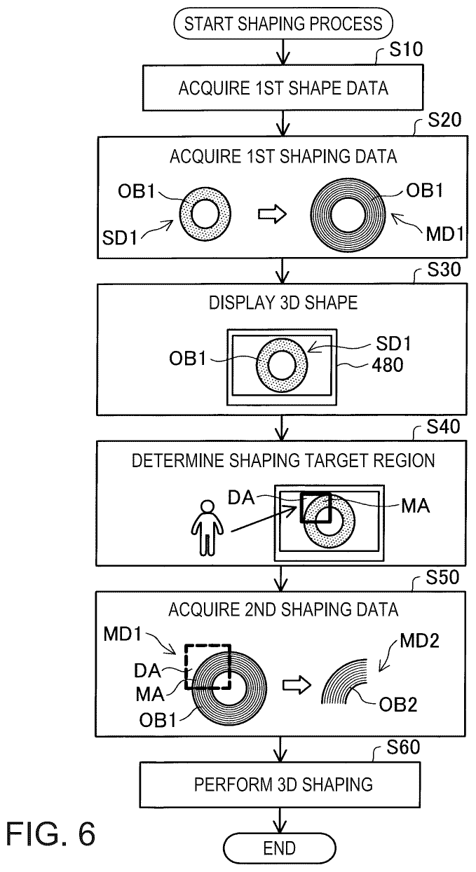

FIG. 6 is a flowchart of a shaping process executed in the three-dimensional shaping system 10. The shaping process is a process that realizes the method for producing the three-dimensional shaped object and the data generation method in the present disclosure. The process in steps S10 to S50 shown in FIG. 6 is executed in the information process device 400, and the process in step S60 is executed in the three-dimensional shaping device 100 The process of steps S10 to S50 corresponds to a process for realizing the data generation method in the present disclosure.

In step S10, the data generation section 411 of the information process device 400 acquires a first shape data SD1. In step S10, the data generation section 411 acquires the first shape data SD1 from, for example, another computer, a recording medium, or the storage device 430. The first shape data SD1 is data representing the three-dimensional shape of the three-dimensional shaped object. Hereinafter, a three-dimensional shaped object that has a three-dimensional shape represented by the first shape data SD1 is also referred to as a first shaping object OB1. The first shape data SD1 is created using three-dimensional CAD software, three-dimensional CG software, or the like. Data that represents a three-dimensional shape, such as the first shape data SD1, is also collectively referred to as “shape data.” For example, as the shape data, data in an STL format or an AMF format is used. In FIG. 6, the three-dimensional shape represented by the shape data is hatched with a dot pattern.

In step S20, the data generation section 411 acquires first shaping data MD1. The first shaping data MD1 is shaping data for shaping the first shaping object OB1. In step S10, for example, the data generation section 411 generates the first shaping data MD1 by analyzing the first shape data SD1 using slicer software, and acquires the first shaping data MD1. Note that in other embodiments, the data generation section 411 may acquire the first shaping data MD1 from another computer or a recording medium. Step S10 and step S20 correspond to a first acquisition step in the present disclosure.

In step S30, the data generation section 411, based on the first shape data SD1 acquired in step S10, displays a three-dimensional shape of the three-dimensional shaped object on the display section 480. Specifically, in step S30, the three-dimensional shape of the first shaping object OB1 is displayed on the display section 480. Step S30 corresponds to a first display step in the present disclosure. Note that in step S30 in the present embodiment, in addition to the three-dimensional shape of the first shaping object OB1, ancillary information (to be described later) is displayed on the display section 480.

In step S40, the data generation section 411 determines, based on a designation region DA that designates a range in the three-dimensional space, a target region MA of the three-dimensional shaped object displayed on the display section 480. Specifically, the target region MA is a region that overlaps with the designation region DA in the three-dimensional shape of the first shaping object OB1 represented by the first shape data SD1. The designation region DA may or may not include a space region where the three-dimensional shape of the first shaping object OB1 does not exist. As shown in FIG. 6, in the first embodiment, the data generation section 411 determines the designation region DA by receiving a designation of the range of the designation region DA from the user via the input device 470. For example, the designation region DA is determined by the user inputting coordinates values representing the range of the designation region DA using a keyboard or by selecting the designation region DA by dragging the range of the designation region DA with a mouse. For example, the designation region DA may be determined as a continuous region including a plurality of separated regions selected by the user. A target portion of the first shaping object OB1, which is a portion corresponding to the target region MA, is actually shaped in the three-dimensional shaping device 100. Hereinafter, in the first shaping object OB1, a portion corresponding to a non-targeted region that is different from the target region MA is also referred to as a “non-targeted portion.” In the present embodiment, the non-targeted portion is not shaped in the three-dimensional shaping device 100.

In step S50, the data generation section 411 selects data of the portion corresponding to the determined target region MA from the first shaping data MD1 to generate second shaping data MD2, and acquires the second shaping data MD2. The second shaping data MD2 is shaping data that is used to shape the second shaping object OB2. The second shaping object OB2 is a part of the first shaping object OB1 and includes at least the target portion. In the present embodiment, the second shaping object OB2 corresponds to the target portion. Step S50 corresponds to a second acquisition step in the present disclosure.

In step S60, the control section 300 of the three-dimensional shaping device 100 performs three-dimensional shaping based on the second shaping data MD2. Specifically, in step S60, the control section 300 first acquires the second shaping data MD2 acquired by the data generation section 411 in step S50. Next, based on the acquired second shaping data MD2, the control section 300 shapes the second shaping object OB2 on the stage 210 by discharging the shaping material from the discharge section 60 toward the stage 210 to stack layers by controlling the discharge section 60 and the movement mechanism 230. Step S60 corresponds to a shaping step in the present disclosure.

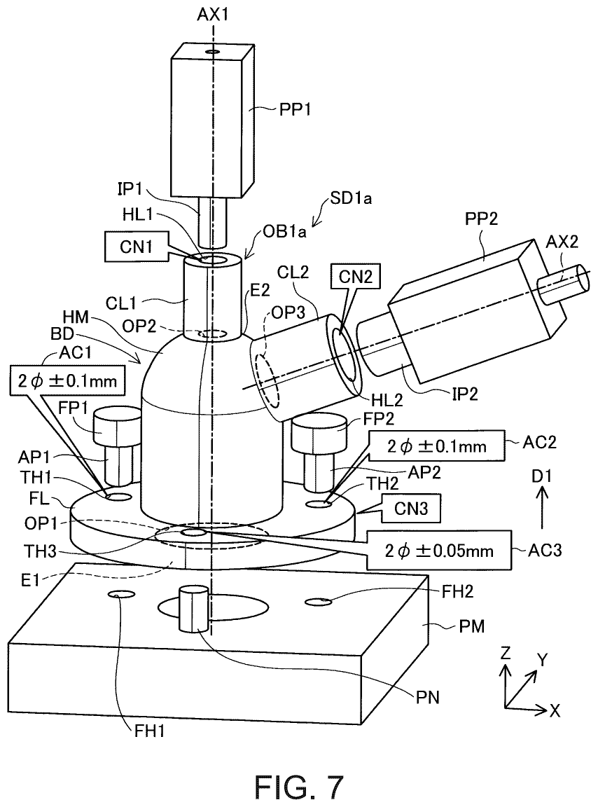

FIG. 7 is an explanatory diagram showing an example of the first shaping object OB1 represented by the first shape data SD1. In FIG. 7, as an example of the first shaping object OB1, a three-dimensional shape of the first shaping object OB1a represented by the first shape data SD1a is shown.

The first shaping object OB1a as a whole has a cylindrical shape that branches in two at an intermediate portion. The first shaping object OB1a has a main body section BD, a first cylindrical section CL1, a second cylindrical section CL2, and a flange shape section FL.

The main body section BD has a hollow cylindrical shape as a whole. The flange shape section FL is provided on a first end E1 side of the main body section BD in an axis AX1 direction. The main body section BD has a hemispherical section HM on a second end E2 side of the main body section BD in the axis AX1 direction. Hereinafter, in the axis AX1 direction, a direction from the first end E1 side toward the second end E2 side is also referred to as a first direction D1. The hemispherical section HM is a hemispherical shape protruding in the first direction D1. The end section of the first direction D1 side of the hemispherical section HM forms the second end E2. Hereinafter, unless otherwise specified, the first shaping object OB1a will be described on the assumption that the first shaping object OB1a is arranged so that the first direction D1 faces the +Z direction.

A first opening section OP1 is formed in the first end E1. A second opening section OP2 is formed in the second end E2. A third opening section OP3 is formed in a curved surface portion of the hemispherical section HM different from the second end E2. Each of the first opening section OP1, the second opening section OP2, and the third opening section OP3 cause the hollow section inside the main body section BD to communicate with the outside.

The first cylindrical section CL1 has a hollow cylindrical shape along the axis AX1. The first cylindrical section CL1 is thinner than the main body section BD. The first cylindrical section CL1 is arranged on the first direction D1 side of the main body section BD so that the first hollow section HL1 of the first cylindrical section CL1 communicates with the second opening section OP2. Specifically, the first cylindrical section CL1 is provided so as to protrude in the +Z direction from the end section of the first direction D1 side of the main body section BD. The second cylindrical section CL2 has a hollow cylindrical shape. The second cylindrical section CL2 is thinner than the main body section BD. The second cylindrical section CL2 is arranged so that an axis AX2 of the second cylindrical section CL2 intersects with the axis AX1. The direction of the axis AX2 is inclined from a direction that is orthogonal to the axis AX1. The second cylindrical section CL2 is arranged on the hemispherical section HM so that the second hollow section HL2 of the second cylindrical section CL2 communicates with the third opening section OP3. Specifically, the second cylindrical section CL2 is provided so as to protrude in the +Z direction and the +X direction from the hemispherical section HM of the main body section BD.

The flange shape section FL has a circular shape flange. The flange shape section FL is arranged so that the thickness direction of the flange shape section FL is along the first direction D1. The flange shape section FL has a first through hole TH1, a second through hole TH2, and a third through hole TH3. Each of the first through hole TH1, the second through hole TH2, and the third through hole TH3 penetrates the flange shape section FL in the thickness direction, that is, in the first direction D1.

In addition to the first shaping object OB1a, a connection member to be connected to the first shaping object OB1a is shown in FIG. 7. Specifically, as connection members, a first pipe member PP1, a second pipe member PP2, a base member PM, a first fixing member FP1, and a second fixing member FP2 are shown in FIG. 7. The first pipe member PP1 has a first insertion section IP1 that is to be inserted and fitted into the first hollow section HL1. The first insertion section IP1 has a cylindrical shape and has an outer diameter slightly smaller than the opening diameter of the first hollow section HL1. The second pipe member PP2 has a second insertion section IP2 that is to be inserted and fitted into the second hollow section HL2. The second insertion section IP2 has a cylindrical shape and has an outer diameter slightly smaller than the opening diameter of the second hollow section HL2. The base member PM has a rectangular plate shape.

The base member PM is arranged so that the thickness direction of the base member PM is along the first direction D1. The base member PM has a pin section PN, a first fixing hole FH1, and a second fixing hole FH2. The pin section PN protrudes from the surface of the base member PM on the first direction D1 side to the first direction D1 side. The pin section PN is a solid cylindrical shape with an outer diameter slightly smaller than the opening diameter of the third through hole TH3, and is inserted and fitted into the third through hole TH3. The first fixing hole FH1 and the second fixing hole FH2 are provided on the surface of the base member PM on the first direction D1 side. The first fixing hole FH1 has substantially the same opening diameter as the first through hole TH1, and is arranged at a position corresponding to the first through hole TH1 in a X-Y direction. Similarly, the second fixing hole FH2 has substantially the same opening diameter as the second through hole TH2, and is arranged at a position corresponding to the second through hole TH2 in the X-Y direction. The first fixing member FP1 has a first shaft section AP1. The first shaft section AP1 has a solid cylindrical shape with a slightly smaller outer diameter than the opening diameter of the first through hole TH1, and is inserted and fitted into the first through hole TH1 and the first fixing hole FH1. The second fixing member FP2 has a second shaft section AP2. The second shaft section AP2 has a solid cylindrical shape with a slightly smaller outer diameter than the opening diameter of the second through hole TH2, and is inserted and fitted into the second through hole TH2 and the second fixing hole FH2. By the first fixing member FP1, the second fixing member FP2, and the pin section PN being fitted in this manner, the flange shape section FL is fixed to the base member PM.

The first shape data SD1 in the present embodiment includes ancillary information. The ancillary information is information tied to the three-dimensional shape of the first shaping object OB1 in the first shape data SD1. The ancillary information in the present embodiment includes accuracy information and connection information. The accuracy information represents required accuracy for each portion of the first shaping object OB1. A “portion of the first shaping object OB1” in the ancillary information is, for example, a portion composed of one or more voxels or one or more polygons. A “portion of the first shaping object OB1” may be a portion grouped for each shape or function of the first shaping object OB1, such as the main body section BD, the flange shape section FL, the first through hole TH1, or the second through hole TH2 described above, for example. The connection information is information regarding a connection of each portion of the first shaping object OB1 with other members.

In the present embodiment, the data generation section 411 is configured to be able to display the ancillary information on the display section 480. For example, on the display section 480, the ancillary information may be displayed in the vicinity of a portion of the first shaping object OB1 related to the ancillary information or in list form. The ancillary information may, when a portion of the first shaping object OB1 related to the ancillary information is selected by the user, also be displayed in a pop-up window on the display section 480 in the vicinity of the portion or in an arbitrary region.

The accuracy information represents dimension accuracy or surface accuracy, for example. FIG. 7 shows first dimension information AC1, second dimension information AC2, and third dimension information AC3 as examples of accuracy information. The first dimension information AC1 is associated with the first through hole TH1 and represents a dimension and dimension accuracy of the opening diameter of the first through hole TH1. The second dimension information AC2 is associated with the second through hole TH2 and represents a dimension and dimension accuracy of the opening diameter of the second through hole TH2. The third dimension information AC3 is associated with the third through hole TH3 and represents a dimension and dimension accuracy of the opening diameter of the third through hole TH3. As shown in FIG. 7, the dimension accuracy represented by the first dimensional information AC1 and the second dimensional information AC2 is +0.1 mm. The dimension accuracy represented by the third dimension information AC3 is +0.05 mm. In other words, in the first shaping object OB1, dimension accuracy required for the opening diameter of the third through hole TH3 is higher than dimension accuracy required for the opening diameters of the first through hole TH1 and the second through hole TH2.

The connection information may, for example, simply be information indicating that some connection member is connected to each portion of the first shaping object OB1, or may be identification information of the connection member to be connected to each portion of the first shaping object OB1. The connection information may also be information representing the three-dimensional shape of the connection member, information representing the dimension of the connection member, or information representing accuracy of the connection member. FIG. 7 shows first connection information CN1, second connection information CN2, and third connection information CN3 as examples of connection information. The first connection information CN1 is associated with the first cylindrical section CL1 and represents connection information relating to a connection between the first cylindrical section CL1 and the first pipe member PP1. The second connection information CN2 is associated with the second cylindrical section CL2, and represents connection information relating to a connection between the second cylindrical section CL2 and the second pipe member PP2. The third connection information CN3 is associated with the flange shape section FL, and represents information relating to a connection between the flange shape section FL and the base member PM, the first fixing member FP1, and the second fixing member FP2. In the present embodiment, connection information is information representing the three-dimensional shape of the connection member. It can also be said that each of the three-dimensional shapes of the first pipe member PP1, the second pipe member PP2, the base member PM, the first fixing member FP1, and the second fixing member FP2 in FIG. 7 represents the three-dimensional shape represented by the connection information.

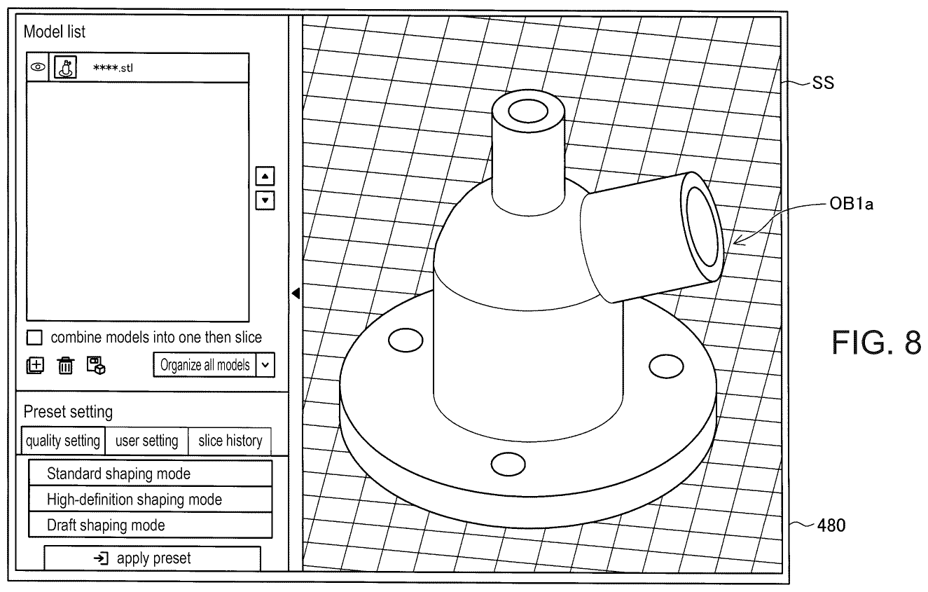

FIG. 8 is an explanatory diagram showing an example in which the first shape data SD1a is read into a slicer software. FIG. 8 shows how a display screen SS of functions of the slicer software is displayed on the display section 480. When the first shape data SD1a is read into the slicer software, as shown in FIG. 8, information representing the three-dimensional shape of the first shaping object OB1a is handled in the slicer software, but the ancillary information is not handled.

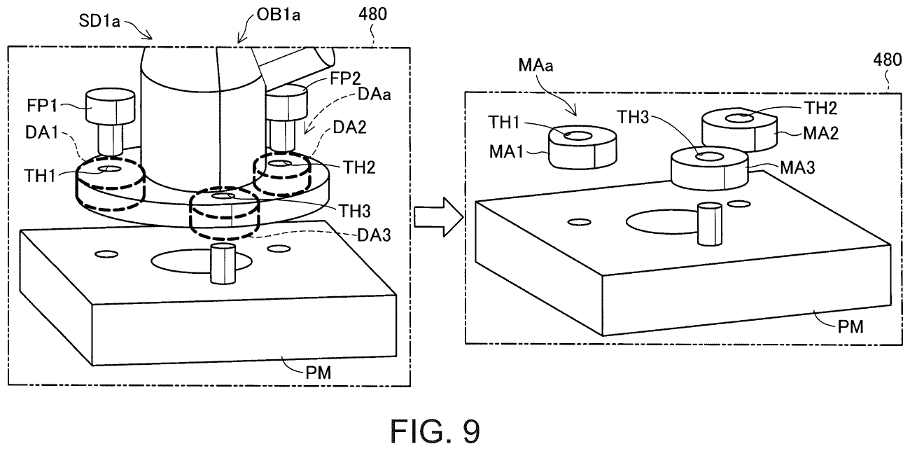

FIG. 9 is an explanatory diagram showing a first example of a determination step. The left part of FIG. 9 shows how a designation region DAa including regions DA1, DA2, and DA3, which are separated from each other, is determined. Each of the regions DA1 to DA3 is a cylindrical region. The shapes and sizes of regions DA1 to DA3 are the same. The region DA1 includes the first through hole TH1. The region DA2 includes the second through hole TH2. The region DA3 includes the third through hole TH3.

In the present embodiment, since ancillary information is displayed on the display section 480 together with the shape of the first shaping object OB1, the user can designate the designation region DA while appropriately checking the ancillary information on the display section 480. For example, in the example of FIG. 9, as a result of one or more regions being designated by the user so as to include the first through hole TH1, the second through hole TH2, and the third through hole TH3, which are associated with accuracy information, the above regions DA1 to DA3 are designated, and then the designation region DAa is determined. The right part of FIG. 9 shows how a target region MAa including regions MA1, MA2, and MA3, which are separated from each other, is determined. The region MA1 is a region of the first shaping object OB1a that overlaps with the region DA1. The region MA2 is a region of the first shaping object OB1a that overlaps with the region DA2. The region MA3 is a region of the first shaping object OB1a that overlaps with the region DA3. Hereinafter, each of a plurality of regions separated from each other in the target region MA, such as regions MA1 to MA3, is also referred to as a portion region.

As shown in the right part of FIG. 9, in the present embodiment, the data generation section 411 causes the display section 480 to display the determined target region MA. In other embodiments, the data generation section 411 may not cause the display section 480 to display the target region MA.

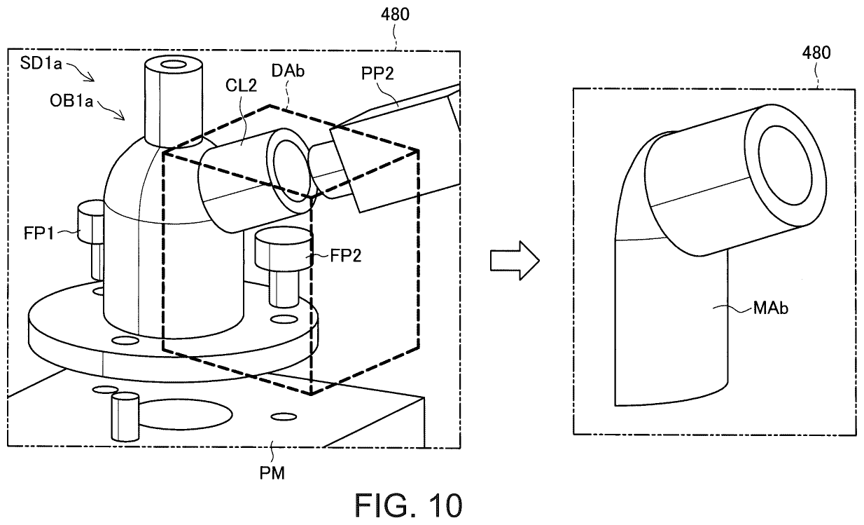

FIG. 10 is an explanatory diagram showing a second example of the determination step. The left part of FIG. 10 shows how a designation region DAb is determined. The designation region DAb is a rectangular parallelepiped shape region. For example, the designation region DAb is determined as a result of one or more regions being designated so as to include the second cylindrical section CL2 that is associated with the second connection information CN2. The right part of FIG. 10 shows how a target region MAb is determined. The target region MAb is a region of the first shaping object OB1a that overlaps with the designation region DAb.

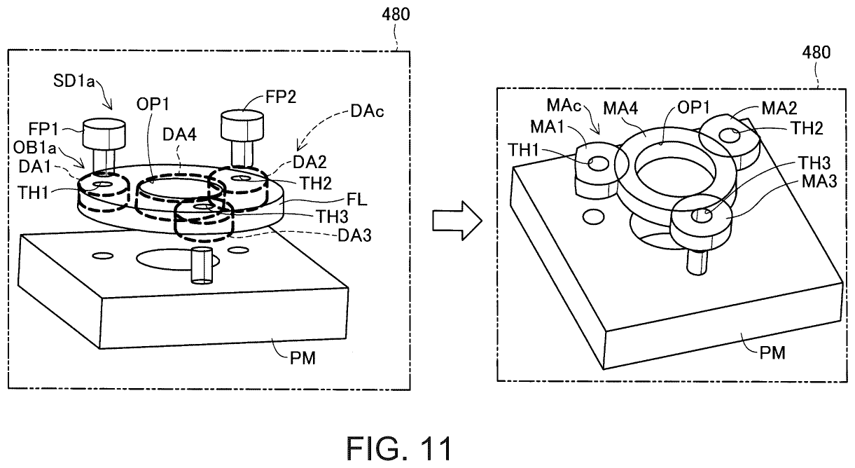

FIG. 11 is an explanatory diagram showing a third example of the determination step. In FIG. 11, for convenience of illustration, a part of the first shaping object OB1a such as the main body section BD is omitted. The left part of FIG. 11 shows how a designation region DAc is determined. The designation region DAc includes a region DA4 in addition to the regions DA1, DA2, and DA3. The region DA4 is a cylindrical shaped region and has a bottom surface that has a larger area than that of regions DA1 to DA3. The region DA4 includes the first opening section OP1. For example, the designation region DAc is determined as a result of one or more regions being designated so as to include the first through hole TH1, the second through hole TH2, and the third through hole TH3 and to include the first opening section OP1. The right part of FIG. 11 shows how a target region MAc that includes the regions MA1, MA2, MA3, and MA4 is determined. The region MA4 is a region of the first shaping object OB1a that overlaps with the region DA4.

As shown in FIGS. 9 to 11, the number, shape, and size of the regions included in the designation region DA may be arbitrary. For example, the number of regions included in the designation region DA is not limited to one, three, or four, and may be two or five or more. The shape of the region included in the designation region DA may be an arbitrary shape such as various cylindrical shapes, various columnar shapes, various conical shapes, a spherical shape, a hemispherical shape, or various shapes including a curved shape or a curved surface shape. The number, shape, and size of regions included in the designation region DA may be selectable by the user through the input device 470.

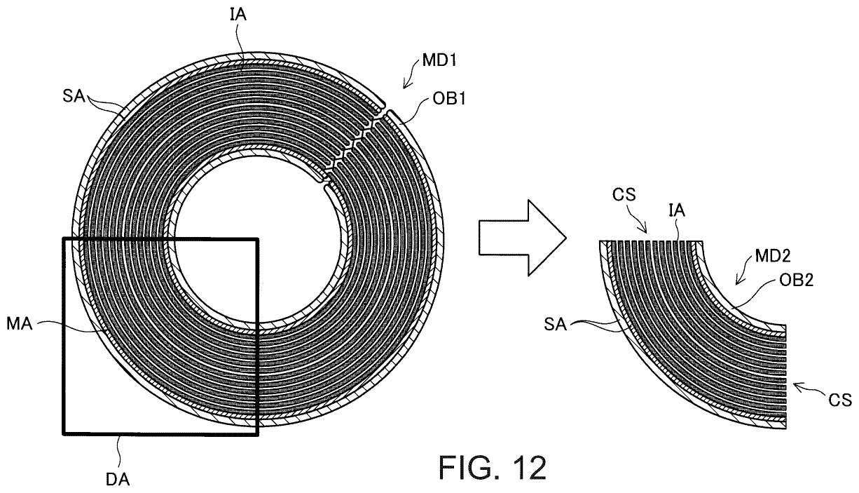

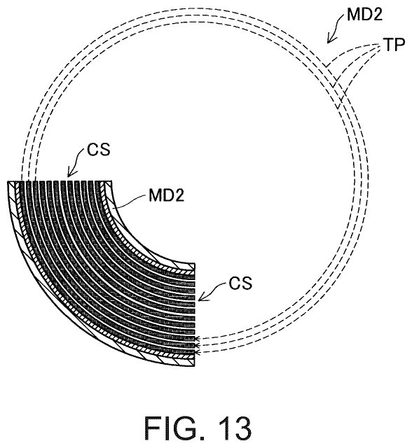

FIG. 12 is a first schematic diagram showing generation of shaping data. FIG. 13 is a second schematic diagram showing generation of the shaping data. FIGS. 12 and 13 show how the second shaping data MD2 is generated for the donut-shaped first shaping object OB1.

First, the data generation section 411 analyzes the first shape data SD1 representing the shape of the first shaping object OB1, and as shown in the left part of FIG. 12, the data generation section 411 generates first shaping data MD1 for shaping the entire first shaping object OB1. When generating the first shaping data MD1, the data generation section 411 generates the first shaping data MD1 by generating shaping paths for an outer shell region SA that represents the outer shell of the first shaping object OB1 and for a filling region IA that exists inner side of the outer shell region SA. Specifically, the data generation section 411 analyzes the first shape data SD1 acquired in step S10, and slices the first shaping object OB1 into a plurality of layers along the X-Y plane. Then, the data generation section 411 determines the shaping paths for shaping the outer shell region SA that forms a contour in each layer and the filling region IA that exists inner side of the outer shell region SA. The shaping path is path information representing the movement path of the nozzle 61. The path information includes data representing a plurality of linear movement paths. Each movement path included in the path information includes discharge amount information representing the discharge amount of the shaping material that will be discharged in the movement path. The data generation section 411 generates shaping paths by generating the path information and the discharge amount information for all the layers constituting the first shaping object OB1. A line width of the shaping path is determined based on a length of a movement path indicated by the shaping path and a discharge amount of the shaping material discharged in the movement path. The left part of FIG. 12 shows, as the shaping path for shaping the first shaping object OB1, shaping paths for two rounds along the contour of the target region MA. It also shows, as a shaping path for shaping the filling region IA, a shaping path whose filling rate will be 100% as a concentric circle shape filling pattern. Concentric circle shape filling pattern refers to a pattern in which the contour shape of the shaped object is gradually reduced toward the center. The number of times of the shaping path for shaping the outer shell region SA, and a filling pattern and a filling rate for shaping the filling region IA, may be arbitrarily set by the user.

Next, as shown in the right part of FIG. 12, the data generation section 411 selects and extracts data of a portion corresponding to the target region MA from the first shaping data MD1 to generate the second shaping data MD2. In the present embodiment, in the second acquisition step, the shaping paths that surround a cutting surface CS, which is where the three-dimensional shape represented by the first shaping data MD1 is cut by the target region MA, is not generated. In other words, in the second acquisition step, no shaping path is newly generated.

FIG. 13 shows how a travel path TP that is different from the shaping path is generated in the second shaping data MD2. In the present embodiment, in the step of generating the second shaping data MD2, the data generation section 411 converts shaping paths included in the data other than the portion corresponding to the target region MA in the first shaping data MD1 into the travel paths TP. The travel path TP is a path to move the nozzle 61 from a discharge end position to a next discharge start position without discharging the shaping material. The data generation section 411 converts the shaping path into the travel path TP by setting the discharge amount information of the shaping path for shaping the portion other than the portion corresponding to the target region MA to zero. Note that the data generation section 411 may constitute a travel path with a travel path that connects the shaping path with the shortest distance.

Note that support data may be included in the second shaping data MD2. When the target portion includes an overhang section, the data generation section 411 generates support data to support the target portion from below. An overhang section is a protruding portion of the three-dimensional shaped object that is not supported from below. In the present embodiment, the term “overhang section” also includes a “bridge section.” A bridge section is, in the three-dimensional shaped object, a bridge shape portion whose both ends are supported. The data generation section 411 generates the support data by specifying a space region below the overhang section and then by generating shaping paths in accordance with a predetermined condition for the space region.

In step S60 of FIG. 6, based on the second shaping data MD2 acquired as described above, the portion of the first shaping object OB1 that includes the target portion is shaped as the second shaping object OB2. In the present embodiment, in step S60, the target portion is shaped as the second shaping object OB2.

According to the first embodiment described above, the target region MA of the first shaping object OB1 displayed on the display section 480 based on the first shape data SD1 is determined based on the designation region DA. Then, in the first shaping data MD1 generated based on the first shape data SD1, by selecting data corresponding to the determined target region MA, the second shaping data MD2 is acquired. Then, three-dimensional shaping is performed based on the acquired second shaping data MD2. Therefore, the shaping time required for test shaping can be shortened and the amount of shaping material used can be reduced. Such an effect is particularly remarkable when performing test shaping of a large-sized three-dimensional shaped object.

In the present embodiment, ancillary information included in the first shape data SD1 is displayed on the display section 480. Therefore, the user can designate the designation region DA while visually checking the three-dimensional shape of the first shaping object OB1 and the ancillary information displayed on the display section 480. By this, the possibility of properly determining the designation region DA and the target region MA can be increased and the test shaping can be performed more effectively. In particular, in the present embodiment, since the ancillary information includes the accuracy information, for example, it is easy to designate the designation region DA for performing test shaping of a portion of the first shaping object OB1 that has higher required accuracy. In the present embodiment, since the ancillary information includes the connection information, for example, it is easy to designate the designation region DA for performing test shaping of a portion of the first shaping object OB1, to which the connection member is connected. It is desirable that a portion of the first shaping object OB1 to which the connection member is connected is shaped so that it has at least accuracy and strength to be able to appropriately connect the connection member. In the present embodiment, as described above, by performing test shaping of the portion of the first shaping object OB1 to which the ancillary information is associated, it is possible to efficiently search for the shaping conditions that enable more appropriately shaping of the three-dimensional shaped object that includes such a portion.

In the first embodiment, by selecting a portion corresponding to the target region MA from the first shaping data MD1 for shaping the entire first shaping object OB1, the second shaping data MD2 for shaping the second shaping object OB2 including the target portion is generated. Therefore, the second shaping object OB2 can be shaped by the same shaping paths as that for shaping the entire first shaping object OB1. By this, shaping accuracy of the target portion can be made closer to shaping accuracy in the case where the entire first shaping object OB1 is shaped. For example, unlike the present embodiment, in an aspect in which data of the portion corresponding to the target region MA is selected from the first shape data SD1, and shaping data is generated based on the selected data, that is, the shape selected in advance, normally, shaping paths of the different aspect from the first shaping data MD1 are generated for portions corresponding to the cutting surface CS shown in FIG. 12. Specifically, in this aspect, for example, in the first shaping data MD1, the shaping paths that shape the filling region IA are generated for a part of the portions corresponding to the cutting surface CS, but in the shaping data generated based on the selected shape, the shaping paths that shape the outer shell region SA are generated for the entire portion corresponding to the cutting surface CS. On the other hand, in the present embodiment, it is possible to generate the shaping paths that shape the filling region IA for a part of the portions corresponding to the cutting surface CS in both the first shaping data MD1 and the second shaping data MD2.

In the first embodiment, since the data generation section 411 receives the designation of the designation region DA from the user, the user can designate an arbitrary range as the designation region DA.

### B. Second Embodiment

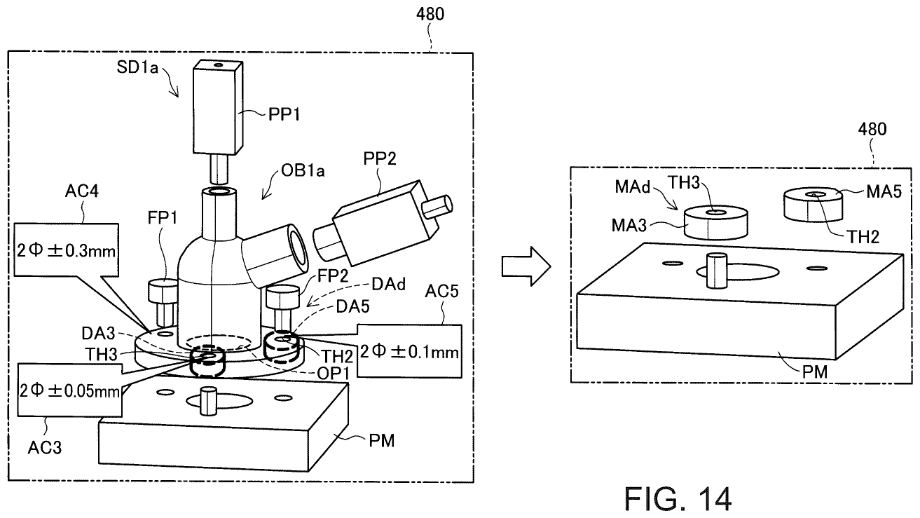

FIG. 14 is an explanatory diagram showing an example of the determination step in a second embodiment. The configuration of a three-dimensional shaping system 10 in the second embodiment is the same as that of the three-dimensional shaping system 10 in the first embodiment. In the second embodiment, unlike the first embodiment, in step S50 of the shaping process shown in FIG. 6, the designation region DA is automatically determined by the data generation section 411 based on the accuracy information. Since the processing contents of steps S10 to S40 and step S60 are the same as those of the first embodiment, the description below will mainly focus on the processing contents of step S50.

In the present embodiment, the first shape data SD1a, similar to the first embodiment, includes the ancillary information including the accuracy information and the connection information. FIG. 14 shows third dimension information AC3, fourth dimension information AC4, and fifth dimension information AC5 as examples of the accuracy information. The third dimension information AC3 is the same as in the first embodiment. The fourth dimension information AC4 is associated with the first through hole TH1 and represents a dimension and dimensional accuracy of the opening diameter of the first through hole TH1. The fifth dimension information AC5 is associated with the second through hole TH2 and represents a dimension and dimensional accuracy of the opening diameter of the second through hole TH2. As shown in FIG. 14, the dimension accuracy represented by the third dimension information AC3, the fourth dimension information AC4, and the fifth dimension information AC5 is ±0.3 mm, ±0.1 mm, and ±0.05 mm, respectively.

As described above, in the present embodiment, in step S50 in FIG. 6, the data generation section 411 determines the designation region DA based on the accuracy information so that the designation region DA includes portions of the first shaping object OB1 whose required accuracy is equal to or greater than a predetermined accuracy threshold. In the present embodiment, the accuracy threshold is 0.2. Therefore, the data generation section 411 determines the designation region DAd by determining one or more regions including the second through hole TH2 and the third through hole TH3 whose required accuracy is equal to or greater than the accuracy threshold based on the accuracy information. The left part of FIG. 14 shows how a designation region DAd, including the regions DA3 and DA5 separated from each other, was determined by the data generation section 411 based on the accuracy information.

The right part of FIG. 14 shows how a target region MAd, including a region MA3 and a region MA5 separated from each other, is determined. Similar to the first embodiment, the region MA3 is a region of the first shaping object OB1a that overlaps with the region DA3. The region MA5 is a region of the first shaping object OB1 that overlaps with the region DA5.

Note that the number, shape, and size of the regions included in the designation region DA in the second embodiment may be arbitrary, similar to the first embodiment. However, it is desirable that the shape of the designation region DA in the second embodiment is determined according to the shape of a portion associated with the ancillary information that is base for the designation region DA. Specifically, in a case where the shape of the portion associated with the ancillary information that is the basis for the designation region DA is a cubic shape, it is desirable that the shape of the designation region DA is an enlarged shape of that cubic shape. In a case where the shape of the portion associated with the ancillary information that is the basis for the designation region DA is a plane shape, it is desirable that the shape of the designation region DA is an enlarged shape of the cubic shape corresponding to the plane shape. For example, the shape of the second through hole TH2 associated with the fifth dimension information AC5 is a cylindrical shape extending along the first direction D1. Therefore, it is desirable that the shape of the designation region DA designated based on the fifth dimension information AC5 is a shape in which the cylindrical shape of the second through hole TH2 is enlarged at least in one of its bottom surface direction and its height direction. In an example different from FIG. 14, for example, in a case where the designation region DA is determined based on the accuracy information associated with the first opening section OP1, it is desirable that the shape of the designation region DA is a shape that is an enlarged cylindrical shape that is the circular shape of the first opening section OP1 extended in its height direction, in one of the bottom surface direction and the height direction of the cylindrical shape. In this way, for example, compared to an aspect where the shape of the designation region DA is determined independently of the shape of the portion associated with the ancillary information that is the basis for the designation region DA, the possibility that the shape of designation region DA is appropriately determined can be increased. Specifically, for example, it can suppress inclusion of an unnecessary region in the designation region DA.

According to the second embodiment described above, in the determination step, the data generation section 411 determines the designation region DA based on the ancillary information included in the first shape data SD1. By this, the target region MA can be determined in consideration of the ancillary information, so the test shaping can be performed more effectively.

In the present embodiment, the data generation section 411 determines the designation region DA based on the accuracy information so as to include a portion whose required accuracy is equal to or greater than the accuracy threshold. Therefore, by using test shaping, it is possible to confirm the actual shaping state of the portion with higher required accuracy.

### C. Third Embodiment

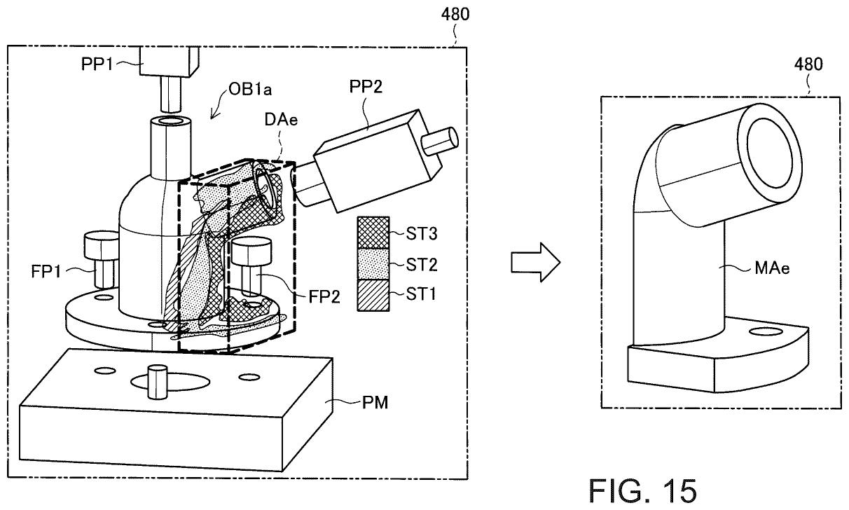

FIG. 15 is an explanatory diagram showing an example of the determination step in a third embodiment. The configuration of a three-dimensional shaping system 10 in a third embodiment is the same as that of the three-dimensional shaping system 10 in the first embodiment. In the third embodiment, unlike the first embodiment, in step S50 of the shaping process shown in FIG. 6, the designation region DA is automatically determined by the data generation section 411 based on stress information included in the ancillary information. Since the processing contents of steps S10 to S40 and step S60 are the same as those of the first embodiment, the description below will mainly focus on the processing contents of step S50.

In the present embodiment, the ancillary information included in the first shape data SD1a includes stress information instead of the accuracy information described in the first embodiment and the second embodiment. The stress information represents stresses for each portion of the first shaping object OB1. The stress information in the present embodiment is associated with each portion of the first shaping object OB1, more specifically, each voxel, based on the simulation result. The simulation here is a stress simulation that simulates an occurrence of stress in the first shaping object OB1. For example, it simulates stresses generated in each portion of the first shaping object OB1 when other members contact or are connected to the first shaping object OB1, or it simulates stresses generated in each portion of the first shaping object OB1 when a fluid flows into the first shaping object OB1.

In the left part of FIG. 15, regions of the first shaping object OB1a where stress was equal to or greater than a predetermined value in the stress simulation are hatched. Specifically, a region where the first stress ST1 has occurred, a region where the second stress ST2 has occurred, and a region where the third stress ST3 has occurred are marked with different hatching. The second stress ST2 is greater than the first stress ST1, and the third stress ST3 is greater than the second stress ST2.

In the present embodiment, in step S50 of FIG. 6, the data generation section 411 determines the designation region DA based on the stress information so that the designation region DA includes a portion of the first shaping object OB1 whose stress is equal to or greater than a predetermined stress threshold. The stress threshold value in the present embodiment is the second stress ST2. The left part of FIG. 15 shows how a rectangular parallelepiped shape designation region DAe is determined so as to include the region where the second stress ST2 occurred and the region where the third stress ST3 occurred. Note that the number, shape, and size of the regions included in the designation region DA in the third embodiment may be arbitrary, similar to the second embodiment. The designation region DA may include only a region where the stress is equal to or greater than the stress threshold. The right part of FIG. 15 shows how a target region MAe is determined. The target region MAe is a region of the first shaping object OB1a that overlaps with the designation region DAe.

In the third embodiment described above, similarly to the second embodiment, the target region MA can be determined in consideration of the ancillary information, so the test shaping can be performed more effectively. In particular, in the present embodiment, the data generation section 411 determines the designation region DA based on the stress information so as to include a portion whose stress is equal to or greater than the stress threshold. Therefore, by using test shaping, it is possible to confirm the actual shaping state of the portion where a higher stress is expected to occur. It is desirable that a portion of the first shaping object OB1 where higher stress is expected to occur to be shaped to a strength that can withstand such stresses, for example. In the present embodiment, by using test shaping, it is possible to efficiently search for shaping conditions that enable more appropriately shaping of the three-dimensional shaped object that includes such a portion. Note that in other embodiments, the aspect of determining the designation region DA based on the stress information is not limited to the above. For example, the designation region DA may be determined so as to include a portion where the stress is equal to or less than the stress threshold.

In other embodiments, the first shape data SD1 may include temperature information as the ancillary information. The temperature information represents a temperature change amount for each portion of the first shaping object OB1. For example, in the same manner as the stress information, the temperature information is, based on a simulation result, associated with each portion of the first shaping object OB1. The simulation here is a temperature change simulation that simulates the temperature change in the first shaping object OB1. For example, it simulates the temperature change that occurs in the first shaping object OB1 when a high heat source or a low heat source is brought into proximity or contact with the first shaping object OB1, or it simulates the temperature change that occurs in the first shaping object OB1 when a fluid flows into the first shaping object OB1. In the case where the first shape data SD1 includes temperature information, the data generation section 411 may determine the designation region DA so as to include a portion of the first shaping object OB1 where the temperature change amount is equal to or greater than a predetermined temperature threshold in the determination step. Specifically, in this case, the data generation section 411 determines the designation region DA so as to include, for example, a portion of the first shaping object OB1 that becomes higher in temperature by heating or a portion thereof that becomes lower in temperature by cooling. In this way, similarly to the second embodiment and the third embodiment, the target region MA can be determined in consideration of the ancillary information, so the test shaping can be performed more effectively. In particular, by using test shaping, it is possible to confirm the actual shaping state of the portion where a larger temperature change is expected to occur. The portion of the first shaping object OB1 where the temperature change is larger is more likely to change in shape and characteristics due to the temperature change than a portion where the temperature change is smaller. In the present embodiment, by using test shaping, it is possible to efficiently search for shaping conditions that enable more appropriately shaping of the three-dimensional shaped object that includes such a portion. Note that the present disclosure is not limited to this, and for example, the designation region DA may be determined so as to include a portion where the temperature change is equal to or lower than the temperature threshold. The manner in which the determination step is executed based on the temperature information is substantially the same as that of replacing the stress simulation in FIG. 15 with a temperature simulation, so the figure is omitted.

In other embodiments, the first shape data SD1 may include fluid velocity information as ancillary information. The fluid velocity information represents the fluid velocity of each portion of the first shaping object OB1 when a fluid is caused to flow in the first shaping object OB1. For example, the fluid velocity information, similarly to the stress information and the temperature information, is associated with each portion of the first shaping object OB1 based on simulation results. The simulation here is a fluid simulation that simulates the flow of a fluid such as a liquid or a gas in the first shaping object OB1. In the case where the first shape data SD1 includes the fluid velocity information, the data generation section 411 may determine the designation region DA so as to include a portion of the first shaping object OB1 where the fluid velocity is equal to or greater than a predetermined fluid velocity threshold in the determination step. In this way, similarly to the second embodiment and the third embodiment, the target region MA can be determined in consideration of the ancillary information, so the test shaping can be performed more effectively. In particular, by using test shaping, it is possible to confirm the actual shaping state of the portion where a larger fluid velocity is expected to occur. A portion of the first shaping object OB1 where the fluid velocity is greater is more likely to receive a larger load due to flow of the fluid than a portion where the fluid velocity is lower. In the present embodiment, by using test shaping, it is possible to efficiently search for shaping conditions that enable more appropriately shaping of the three-dimensional shaped object that includes such a portion. Note that in this case, the way the determination step is executed is similar to that of replacing the stress simulation in FIG. 15 with the fluid simulation, so the figure is omitted.

The present disclosure is not limited to the above, for example, the designation region DA may be designated so as to include a portion of the first shaping object OB1 where the fluid velocity is equal to or lower than the fluid velocity threshold. In a portion of the first shaping object OB1 where the fluid velocity is lower, for example, the flow of the fluid tends to stagnate due to the surface accuracy and the dimension accuracy of that portion. Therefore, by determining the designation region DA so as to include the portion where the fluid velocity is equal to or less than the fluid velocity threshold, by using test shaping, it is possible to efficiently search for the shaping conditions that enable more appropriately shaping the three-dimensional shaped object that includes such a portion.

### D. Fourth Embodiment

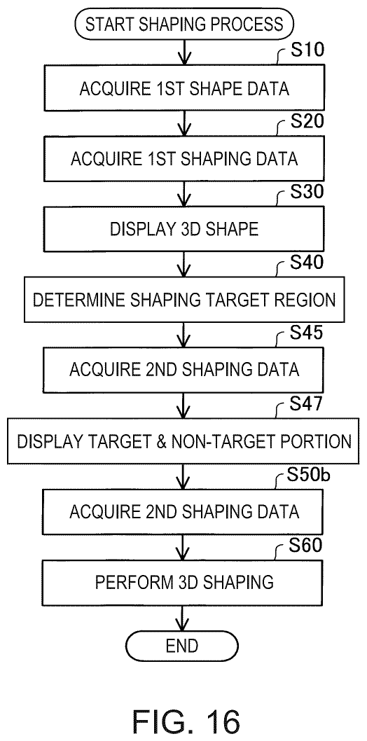

FIG. 16 is a flowchart of a shaping process in a fourth embodiment. A configuration of a three-dimensional shaping system 10 in a fourth embodiment is the same as that of the three-dimensional shaping system 10 in the first embodiment. Unlike the first embodiment, the shaping process in the fourth embodiment has a second shape acquisition step and a second display step. Note that in FIG. 16, the same step numbers are used for the same steps as in FIG. 6. The points of the shaping process that are not particularly described are the same as in the first embodiment.

In step S45, the data generation section 411 acquires second shape data from the first shape data SD1. The second shape data of the first shape data SD1 represents the shape of each portion region and the shape of the connection region that connects each portion region. The three-dimensional shape represented by the second shape data is a part of the three-dimensional shape of the first shaping object OB1 represented by the first shape data SD1. The step of acquiring the second shape data as in step S45 is also referred to as the second shape acquisition step.

In step S47, the data generation section 411 executes the second display step. The second display step is a step of displaying the target portion and the non-targeted portion of the first shaping object OB1 on the display section 480. In the second display step, the data generation section 411 displays the non-targeted portion on the display section 480 in a simplified manner compared to the target portion. Note that in the present embodiment, in the second display step, the non-targeted portion and the target portion are simultaneously displayed on the display section 480 for at least some of the time. Simplification here means that at least one of the following is executed: omitting part of the three-dimensional shape displayed, or reducing the number of pixels of the three-dimensional shape displayed. Therefore, in the second display step, the non-targeted portion is displayed on the display section 480 in a state where more portions are omitted or in a state where the number of pixels is reduced as compared to the target portion. For example, in the second display step, the target portion is displayed without omitting the shape or reducing the number of pixels, while the non-targeted portion is displayed with a shape omitted or the number of pixels reduced. In the second display step, the data generation section 411 may display, on the display section 480, information indicating whether the three-dimensional shape displayed on the display section 480 is a target portion or a non-targeted portion, for example. Note that the portion region above corresponds to the target portion, and the connection region above corresponds to the non-targeted portion.

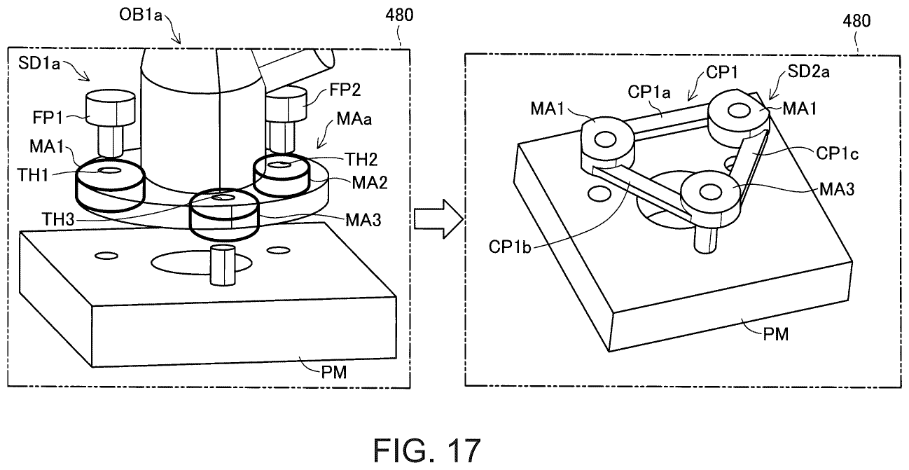

FIG. 17 is an explanatory diagram showing an example of the second shape acquisition step and the second display step in the fourth embodiment. The left part of FIG. 17 shows a target region MAa as an example of the target region MA determined in the determination step. Note that in the present embodiment, the designation region DAa that is the basis for the target region MAa may be, for example, one designated by the user or one automatically determined by the data generation section 411 based on the ancillary information. The right part of FIG. 17 shows second shape data SD2a acquired as an example of the second shape data based on the target region MAa. The second shape data SD2a represents the shapes of the regions MA1, MA2, and MA3, which are portion regions, and the shape of a connection region CP1 that connects each of the portion regions. The connection region CP1 includes a connection region CP1a, a connection region CP1b, and a connection region CP1c. The connection region CP1a is a region that linearly connects between the region MA1 and the region MA2. The connection region CP1b is a region that linearly connects between the region MA1 and the region MA3. The connection region CP1c is a region that linearly connects between region MA1 and region MA3.

It could also be said that the right part of FIG. 17 shows an example of a how the target portion and the non-targeted portion are displayed in the second display step. Specifically, on the right part of FIG. 17, the shapes of the portion regions MA1, MA2, and MA3, which correspond to the target portion, are displayed on the display section 480 without being simplified. On the other hand, on the right part of FIG. 17, only the shapes of the connection regions CP1a to CP1c are displayed among the non-targeted portions. In other words, the non-targeted portion is displayed in a simplified manner.

In the present embodiment, in the second acquisition step in step S50b shown in FIG. 16, the data generation section 411 selects the part of the first shaping data MD1 corresponding to the second shape data to obtain the second shaping data MD2. By this, in the shaping step of step S60 in the present embodiment, based on the second shaping data MD2, the second shaping object OB2 having a shape corresponding to each portion region and the connection region is shaped on the stage 210.

According to the fourth embodiment described above, in the second display step, the non-targeted portion is displayed on the display section 480 in a simplified manner compared to the target portion. Therefore, while the target portion is mainly displayed on the display section 480, a positional relationship between the target portion and the non-targeted portion in the first shaping object OB1 can be shown on the display section 480. By this, the user can confirm, for example, prior to the shaping step, the shape of the target portion and the positional relationship between the target portion and the non-targeted portion on the display section 480 with good visibility. For example, compared to when the non-targeted portion is displayed on the display section 480 without being simplified, the processing load of the information process device 400 can be suppressed.

In the present embodiment, in the second shape acquisition step, the second shape data that represents the shape of each portion region and the shape of the connection region that connects the portion regions is acquired. Then, in the second acquisition step, among the first shaping data MD1, data of the portion corresponding to the second shape data is selected, and second shaping data MD2 is acquired. Therefore, even in a case where a plurality of portion regions separated from each other are included in the target region MA, it is possible to shape a three-dimensional shaped object in which the respective portion regions are appropriately connected in the test shaping. Therefore, for example, by using test shaping, in terms of management and transportation of the three-dimensional shaped object shaped, it is possible to improve the convenience of the user. Note that in other embodiments, for example, only one of acquiring the second shaping data MD2 by selecting the data of the portion corresponding to the second shape data and displaying the non-targeted portion in a simplified manner as compared to the target portion may be executed.

### E. Fifth Embodiment

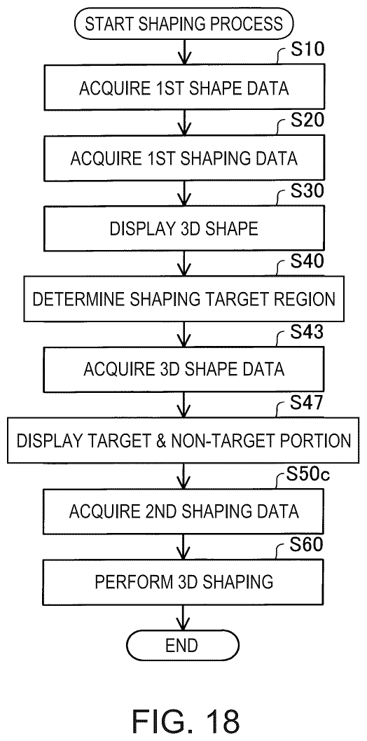

FIG. 18 is a flowchart of the shaping process in a fifth embodiment. A configuration of three-dimensional shaping system 10 in a fifth embodiment is the same as that of the three-dimensional shaping system 10 in the first embodiment. Unlike the fourth embodiment, a shaping process in the fifth embodiment has a third shape acquisition step instead of the second shape acquisition step. Note that in FIG. 18, the same step numbers are used for the same steps as in FIG. 16. The points of the shaping process that are not particularly described are the same as in the fourth embodiment.

In step S43, the data generation section 411 acquires third shape data from the first shape data SD1. The third shape data is data representing a shape of the target region MA and a shape of an extracted region in the first shape data SD1. An extracted region is a region that is extracted to maintain a height of the target region MA in the layer stacking direction in the second shaping data MD2 at the same height as a height of the target region MA in the layer stacking direction in the first shaping data MD1. The three-dimensional shape represented by the third shape data is a part of the three-dimensional shape of the first shaping object OB1. The step of acquiring the third shape data as in step S43 is also referred to as the third shape acquisition step. The extracted region corresponds to the non-targeted portion.

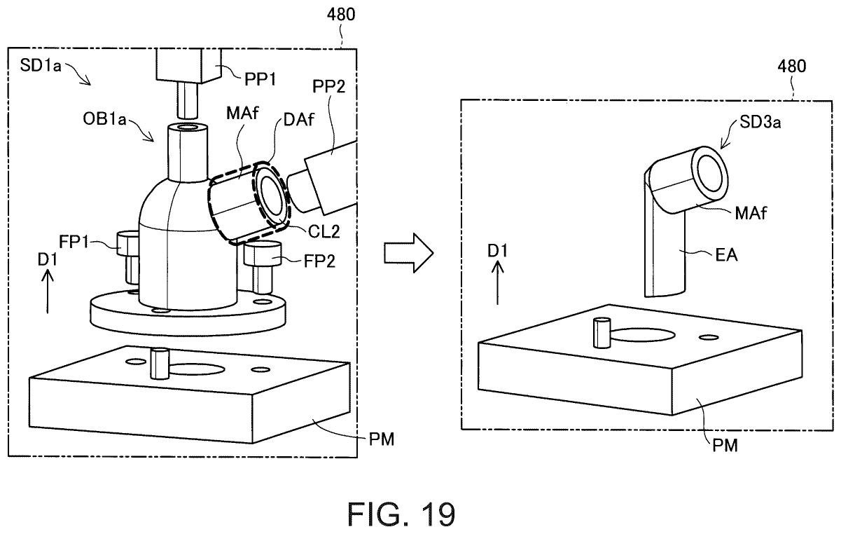

FIG. 19 is an explanatory diagram showing an example of a third shape acquisition step and a second display step in the fifth embodiment. The left part of FIG. 19 shows a target region MAf, as an example of the target region MA, that was determined based on a designation region DAf. Note that the designation region DAf may be, for example, one designated by the user or one automatically determined by the data generation section 411 based on the ancillary information. The designation region DAf includes the second cylindrical section CL2. The target region MAf includes only the second cylindrical section CL2 of the first shaping object OB1a. The target region MAf is located further to the first direction D1 side than the first end E1 of the first shaping object OB1. Here, if the first shaping object OB1a is shaped in the first direction D1, as the layer stacking direction, in accordance with the first shaping data MD1 for shaping the shaping object OB1a, then the target portion corresponding to the target region MAf will be shaped at a position separated from the first end E1 of the first shaping object OB1a in the first direction D1, that is, at a position higher than the upper surface of the stage 210. On the other hand, if the target portion corresponding to the target region MAf is shaped in the first direction D1, as the layer stacking direction, in accordance with the second shaping data MD2 acquired by selecting, from the first shaping data MD1, only the data of the portion corresponding to the target region MAf, the target portion will be shaped immediately on the upper surface of the stage 210, that is, at the same position as the stage 210 in the first direction D1.

The right part of FIG. 19 shows, as an example of the third shape data, third shape data SD3a acquired based on the target region MAf. The third shape data SD3a represents a shape of the target region MAf and a shape of an extracted region EA. The extracted region EA is a region that connects the first end E1 and the target region MAf. It can also be said that the right part of FIG. 19 shows an example of a state in which the target portion and the non-targeted portion are displayed in the second display step. Specifically, in the right part of FIG. 19, the shape of the target region MAf corresponding to the target portion is displayed on the display section 480 without being simplified. On the other hand, in the right part of FIG. 19, only the shape of the extracted region EA among the non-targeted portions is displayed. In other words, the non-targeted portion is displayed in a simplified manner.

In the present embodiment, in the second acquisition step of step S50c shown in FIG. 18, the data generation section 411 selects data of the portion of the first shaping data MD1 corresponding to the third shape data to acquire the second shaping data MD2. By this, in the shaping step of step S60 in the present embodiment, the second shaping object OB2 having a shape corresponding to the target region MA and the extracted region is shaped on stage 210 based on the second shaping data MD2.

According to the fifth embodiment described above, while mainly displaying the target portion on the display section 480, the positional relationship between the target portion and the non-targeted portion in the first shaping object OB1 can be shown on the display section 480.

In the present embodiment, in the third shape acquisition step, third shape data representing the shape of the target region MA and the shape of the extracted region are acquired. Then, in the second acquisition step, the second shaping data MD2 is acquired, in which the data of the portion corresponding to the third shape data was selected from the first shaping data MD1. Therefore, the height of the target region MA in the layer stacking direction in the second shaping data MD2 can be maintained at the same height as the height of the target region MA in the layer stacking direction in the first shaping data MD1. Here, the distance of the target region MA from the stage 210 or the shaping section 110 during shaping can be changed depending on the height of the target region MA in the layer stacking direction. By this, the amount of heat applied from the barrel heater 58 or the stage heater 212 to the target region MA changes depending on the height of the target region MA in the layer stacking direction. Therefore, if the height of the target region MA in the layer stacking direction in the second shaping data MD2 and the height of the target region MA in the layer stacking direction in the first shaping data MD1 are different from each other, the shape and characteristics of the target portion may be different between the second shaping object OB2 and the first shaping object OB1. In the present embodiment, it is possible to suppress a difference in shape or characteristic of the target portion caused by such a difference in height of the target region MA in the layer stacking direction.

Note that in other embodiments, the shaping process may include, for example, both the second shape acquisition step and the third shape acquisition step. In addition, it may be executed only one of selecting the data of the portion corresponding to the third shape data and acquiring the second shaping data MD2, or displaying the non-targeted portion in a simplified manner compared to the target portion.

### F. Sixth Embodiment

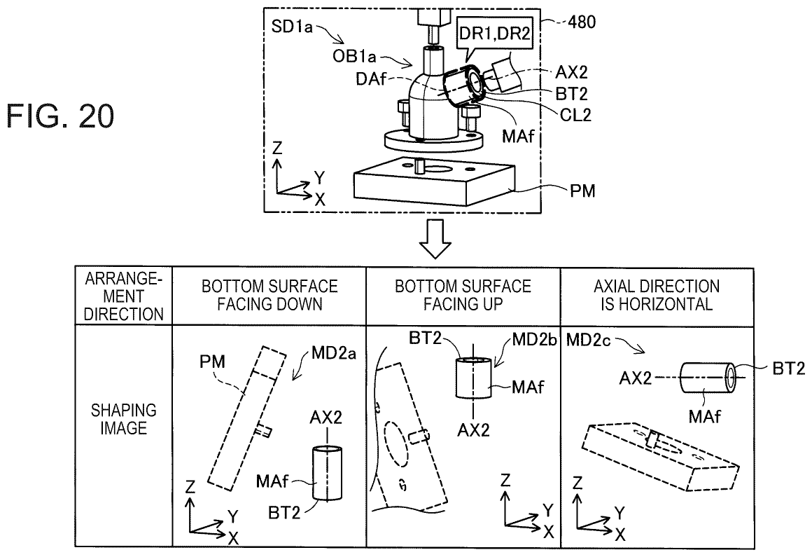

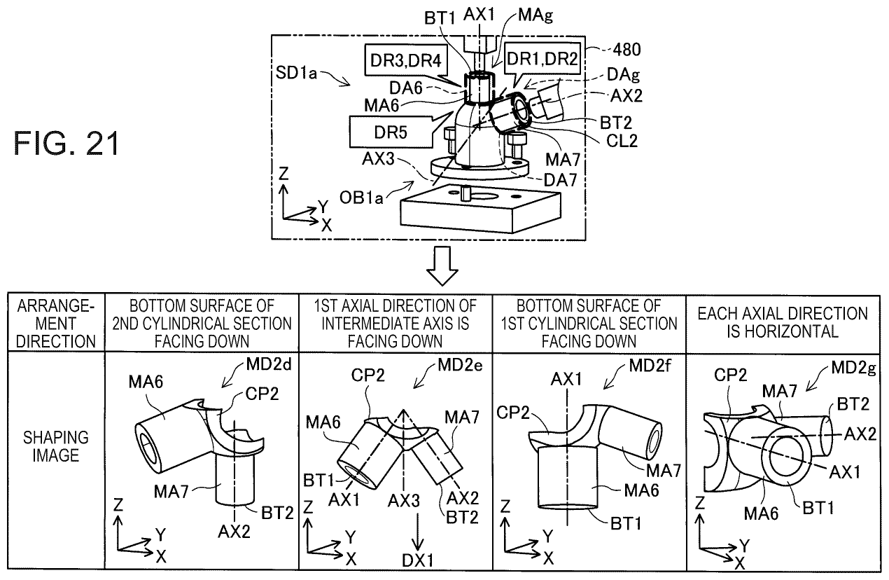

FIG. 20 is an explanatory diagram showing a first example of the second acquisition step in a sixth embodiment. FIG. 21 is an explanatory diagram showing a second example of the second acquisition step in the sixth embodiment. A configuration of the three-dimensional shaping system 10 in the sixth embodiment is the same as that of the three-dimensional shaping system 10 in the first embodiment. In the sixth embodiment, unlike the first embodiment, in the second acquisition step of step S50 of the shaping process shown in FIG. 6, direction information is acquired and an arrangement direction of the target region MA in the second shaping data MD2 is determined based on the acquired direction information. In the present embodiment, since the processing contents of step S10 to step S40 and step S60 are the same as those of the first embodiment, the description below will mainly focus on the processing contents of step S50.

The direction information represents the direction of the three-dimensional shape included in the target region MA. In the present embodiment, the direction information represents one of a surface direction of a plane section included in the target region MA, an axial direction of an axis section included in the target region MA, and a longitudinal direction of an elongated section included in the target region MA. The axis section is any of various axis-like sections such as a rod-shaped section, a column shape section, and a cylindrical section in the target region MA. The plane section does not have to be composed as a uniform plane. For example, it may be a plane with grooves or recess sections formed on the surface, or a plane with protrusions or protrusion sections formed on the surface. The elongated section is a section where the length in one of the three directions that are mutually orthogonal is greater than the lengths in the other two directions. In the second acquisition step, the data generation section 411 may acquire the direction information previously associated with each portion of the first shaping object OB1 in the first shape data SD1, for example. The data generation section 411 may also acquire the direction information by analyzing the three-dimensional shape of each portion of the first shaping object OB1 in the first shape data SD1, for example.

In the present embodiment, in the second acquisition step, the data generation section 411 determines an arrangement direction in the second shaping data MD2 so that the direction represented by the obtained direction information and a surface direction of the stage 210 are parallel or orthogonal to each other. Determining the arrangement direction of the target region MA in the second shaping data MD2 is synonymous with determining the slice direction in which the target region MA is sliced into layers in the second shaping data MD2. Hereinafter, the “arrangement direction of the target region MA in the second shaping data MD2” is also simply referred to as an “arrangement direction in the second shaping data MD2” or an “arrangement direction.” The surface direction of the stage 210 is also referred to as the “stage surface direction.”

In the example of FIG. 20, a target region MAf similar to that of the fifth embodiment is shown as an example of the target region MA. In the example of FIG. 20, as the direction information of the target region MAf, direction information DR1 representing the surface direction of a bottom surface BT2 of the second cylindrical section CL2 and direction information DR2 representing the axis AX2 direction of the second cylindrical section CL2 are acquired. The bottom surface BT2 is a bottom surface of the second cylindrical section CL2 on the side opposite to the main body section BD.

The lower part of FIG. 20 shows how, based on at least one piece of direction information among the pieces of direction information above, a plurality of pieces of second shaping data MD2a, MD2b, and MD2c are acquired, each with a different arrangement direction. Note that in FIGS. 20 and 21, the stage surface direction is the X-Y direction. Further, in the lower part of FIG. 20 and the lower part of FIG. 21, the target region MA is arranged so that the first direction D1 faces a direction different from the +Z direction. In the lower part of FIG. 20, the shape of the base member PM is schematically shown by broken line in order to facilitate understanding of the technique.

The arrangement direction in the second shaping data MD2a and the second shaping data MD2b is determined so that the stage surface direction is parallel to the surface direction of the bottom surface BT2 represented by the direction information DR1, or so that the stage surface direction is orthogonal to the axis AX2 represented by the direction information DR2. The arrangement direction in the second shaping data MD2a is determined so that the bottom surface BT2 faces the −Z direction. The arrangement direction in the second shaping data MD2b is determined so that the bottom surface BT2 faces the +Z direction. By this, the layer stacking direction in the second shaping data MD2a and the second shaping data MD2b is determined to be a direction along the first direction D1. The arrangement direction in the second shaping data MD2c is determined so that the stage surface direction is parallel to the direction represented by the direction information DR2, or so that the stage surface direction is orthogonal to the direction represented by the direction information DR1. By this, the layer stacking direction in the second shaping data MD2c is determined to be a direction along the surface direction of the bottom surface BT1.

In the example of FIG. 21, a target region MAg determined based on a designation region DAg is shown as an example of the target region MA. The designation region DAg includes regions DA6 and DA7, which are separated from each other. Note that the designation region DAg may be, for example, one designated by the user or one automatically determined by the data generation section 411 based on the ancillary information. The target region MAg includes portion regions MA6 and MA7, which are separated from each other. The region DA6 includes the first cylindrical section CL1. The region MA6 is a region that overlaps with the region DA6 of the first shaping object OB1a, and includes only the first cylindrical section CL1 of the first shaping object OB1a. The region DA7 is a region similar to the designation region DAf and includes the second cylindrical section CL2. The region MA7 is a region similar to the target region MAf and includes only the second cylindrical section CL2 of the first shaping object OB1a. In the example of FIG. 21, in addition to direction information DR1 and direction information DR2, direction information DR3, DR4, and DR5 are acquired as direction information for the target region MAg. The direction information DR3 represents a surface direction of the bottom surface BT1 of the first cylindrical section CL1. The bottom surface BT1 is the bottom surface of the first cylindrical section CL1 on the first direction D1 side. The direction information DR4 represents the axial direction of the first cylindrical section CL1. The direction information DR5 represents a direction of an intermediate axis AX3 that bisects an angle between the first cylindrical section CL1 and the second cylindrical section CL2. Specifically, the intermediate axis AX3 is an axis that bisects a smaller angle of the angles formed by the axis AX1 of the first cylindrical section CL1 and the axis AX2 of the second cylindrical section CL2. Of the directions along the intermediate axis AX3, a direction from the main body section BD side toward the bottom surface BT1 side and the bottom surface BT2 side is also referred to as the first axis direction DX1.

The lower part of FIG. 21 shows how a plurality of pieces of second shaping data MD2d, MD2e, MD2f, and MD2g in which different layer stacking directions are set are acquired based on the above direction information. The second shaping data MD2d to MD2g is acquired by selecting data of the portion corresponding to the second shape data representing the shape of regions MA6 and MA7, which are portion regions, and the shape of a connection region CP2 that connects the region MA6 and region MA7, among the first shaping data MD1 that is used to shape the first shaping object OB1a. The arrangement direction in the second shaping data MD2d is determined so that the stage surface direction is parallel to a direction represented by the direction information DR1, or so that the stage surface direction is orthogonal to the direction represented by the direction information DR2. Specifically, the arrangement direction in the second shaping data MD2d is determined so that the bottom surface BT2 faces the −Z direction. The arrangement direction in the second shaping data MD2e is determined so that the stage surface direction is orthogonal to the direction of the intermediate axis AX3 represented by the direction information DR5. Specifically, the arrangement direction in the second shaping data MD2e is determined so that the first axis direction DX1 faces the −Z direction. The arrangement direction in the second shaping data MD2f is determined so that the stage surface direction is parallel to the surface direction of the bottom surface BT1 represented by the direction information DR3, or so that the stage surface direction is orthogonal to the axial direction of the first cylindrical section CL1 represented by the direction information DR4. Specifically, the arrangement direction in the second shaping data MD2f is determined so that the bottom surface BT1 faces the −Z direction. The arrangement direction in the second shaping data MD2g is determined so that the stage surface direction is parallel to the direction represented by the direction information DR2 and the direction represented by the direction information DR4, or so that the stage surface direction is orthogonal to the direction represented by the direction information DR1 and the direction represented by the direction information DR3.

Note that in other embodiments, for example, prior to the shaping step, the target region MA that is rotated based on the direction information of the target region MA may be displayed on the display section 480 as shown in the lower part of FIG. 20 or the lower part of FIG. 21. Such a display may, for example, be executed prior to the acquisition of the second shaping data MD2, or may be executed after the acquisition of the second shaping data MD2.

According to the sixth embodiment described above, in the second acquisition step, the direction information is acquired, and based on the acquired direction information, the layer stacking direction in the second shaping data MD2 is determined. Therefore, the arrangement direction of the target region MA in the second shaping data MD2 can be easily determined.

In the present embodiment, in the second acquisition step, the arrangement direction of the target region MA in the second shaping data MD2 is determined so that the direction represented by the direction information is parallel to the stage surface direction. The direction information represents one of the surface directions of the plane section included in the target region MA, the axial direction of the axis section included in the target region MA, and the longitudinal direction of the elongated section included in the target region MA. According to this aspect, the second shaping object OB2 can be shaped in a posture with a high probability of being able to appropriately shape the target portion. For example, if the surface direction of the plane section included in the target region MA is parallel to the stage surface direction, there is a high probability that the plane section can be shaped so that the surface accuracy of the plane section is higher than when the respective directions intersect with each other. If the axial direction of the axis section included in the target region MA is parallel to the stage surface direction, there is a high probability that the outer circumferential surface or the inner circumferential surface of the axis section can be smoothly shaped in the axial direction, compared to when the directions intersect each other. If the longitudinal direction of the elongated section included in the target region MA is parallel to the stage surface direction, there is a high probability that the elongated section can be shaped more efficiently.

In the present embodiment, a plurality of pieces of second shaping data MD2, in which different arrangement directions are determined based on one or more pieces of direction information about the target region MA, are acquired. Therefore, it is possible to efficiently search for the arrangement direction where the target portion can be more appropriately shaped. By this, for example, the arrangement direction that was found as a result of searching for the arrangement direction and that can more appropriately shape the target portion, can be adopted as the direction of the first shaping object OB1 when shaping the entire first shaping object OB1 in accordance with the first shaping data MD1.

### G. Other Embodiments

G1. In each of the above embodiments, it is preferable that the ancillary information includes at least one piece of the accuracy information, the stress information, the temperature information, and the fluid velocity information. In this way, for example, based on the first shape data SD1, the accuracy information, stress information, temperature information and fluid velocity information can be displayed on the display section 480 together with the three-dimensional shape of the first shaping object OB1, and the user can specify the designation region DA while visually checking the three-dimensional shape and the various ancillary information displayed on the display section 480. Alternatively, the data generation section 411 can determine the designation region DA by taking into account the accuracy information, the stress information, the temperature information, and the fluid velocity information included in the first shape data SD1, and then determine the target region MA. By this, test shaping can be performed more effectively. However, the ancillary information may not include the accuracy information, the stress information, the temperature information, and the fluid velocity information, or may include only information different from these. For example, the ancillary information may include only the connection information. The first shape data SD1 may not include the ancillary information.

G2. In each of the above embodiments, in the second acquisition step, a shaping path that surrounds the cutting surface CS is not generated. However, in the second acquisition step, a shaping path that surrounds at least a part of the cutting surface CS may be generated. In other words, in the second acquisition step, a new shaping path may be generated.

G3. In each of the above embodiments, for example, the control section 300 may have a function as the information process device 400. In this case, the information process device 400 may not be provided separately from the control section 300.

G4. In each of the above embodiments, the shaping section 110 plasticizes the material using the flat screw 40. However, the shaping section 110 may plasticize the material by rotating an inline screw, for example. In addition, the shaping section 110 may plasticize filamentous shape material with a heater.

G5. In each of the above embodiments, the material push out method of laminating the plasticized material has been described as an example, but the present disclosure can be applied to various methods such as an ink jet method, a direct metal deposition (DMD) method, and a binder jet method.

### H. Other Aspects

The present disclosure is not limited to the above-described embodiments, and can be realized in various aspects without departing from the spirit thereof. For example, the present disclosure can also be realized by the following aspects. The technical features in the above-mentioned embodiments corresponding to the technical features in the respective aspects described below can be appropriately replaced or combined in order to solve some or all of the problems of the present disclosure or to achieve some or all of the effects of the present disclosure. Unless the technical features are described as essential in the present specification, the technical features can be appropriately deleted.

(1) According to a first aspect of the present disclosure, a method for producing a three-dimensional shaped object is provided. This method for producing the three-dimensional shaped object includes a first acquisition step for acquiring first shape data representing a three-dimensional shape of the three-dimensional shaped object and first shaping data that is generated based on the first shape data and that is for shaping the three-dimensional shaped object; a first display step for displaying the three-dimensional shaped object on a display section based on the first shape data; a determination step for determining a target region of the three-dimensional shaped object that was displayed on the display section based on a designation region that designates a range in three-dimensional space; a second acquisition step for selecting data of a portion corresponding to the target region in the first shaping data and acquiring second shaping data; and a shaping step, based on the second shaping data, for performing three-dimensional shaping to stack layers by discharging shaping material from a discharge section toward a stage. According to this aspect, the shaped object corresponding to the target region of the three-dimensional shaped object is shaped. Therefore, when the test shaping is performed to confirm the actual shaping state of a part of the three-dimensional shaped object, it is possible to suppress shaping of portions other than the portion that needs to be confirmed.

(2) The above aspect may be configured such that the first shape data includes at least one piece of information including at least one of accuracy information that indicates a required accuracy for each portion of the three-dimensional shaped object, stress information indicating stress for the each portion, temperature information that indicates a temperature change amount for the each portion, or fluid velocity information that indicates a fluid velocity of fluid for the each portion when the fluid is caused to flow in the three-dimensional shaped object. According to this aspect, various kinds of information can be displayed on the display section together with the three-dimensional shape based on the first shape data, and the designation region and the target region can be determined based on the various kinds of information included in the first shape data.

(3) The above aspect may be configured such that the determination step determines the designation region based on the at least the one piece of information. According to this aspect, since the target region can be determined in consideration of various kinds of information included in the first shape data, the test shaping can be performed more effectively.

(4) The above aspect may be configured such that the determination step determines, based on the accuracy information, the designation region so that the designation region includes a portion of the three-dimensional shaped object whose required accuracy is equal to or greater than a predetermined threshold value. According to this aspect, by using test shaping, it is possible to confirm the actual shaping state of the portion with higher required accuracy.

(5) The above aspect may be configured such that the first shape data includes the stress information and the determination step determines, based on the stress information, the designation region so that the designation region includes a portion of the three-dimensional shaped object whose stress is equal to or greater than a predetermined threshold value. According to the present aspect, by using test shaping, it is possible to confirm the actual shaping state of the portion where higher stress is expected to occur.

(6) The above aspect may be configured such that the first shape data includes the temperature information and the determination step determines, based on the temperature information, the designation region so that the designation region includes a portion of the three-dimensional shaped object whose temperature change amount is equal to or greater than a predetermined threshold value. According to the present aspect, by using test shaping, it is possible to confirm the actual shaping state of the portion where a larger temperature change is expected to occur.

(7) The above aspect may be configured such that the first shape data includes the fluid velocity information and the determination step determines, based on the fluid velocity information, the target region so that the designation region includes a portion of the three-dimensional shaped object whose fluid velocity is equal to or greater than a predetermined threshold. According to the present aspect, by using test shaping, it is possible to confirm the actual shaping state of the portion where a larger fluid velocity is expected to occur.

(8) The above aspect may be configured such that further including a second display step for displaying, on the display section, a target portion corresponding to the target region of the three-dimensional shaped object and a non-targeted portion corresponding to a region of the three-dimensional shaped object different from the target region, wherein the second display step displays the non-targeted portion in a simplified manner compared to the target portion. According to this embodiment, while the target portion is mainly displayed on the display section, the positional relationship between the target portion and the non-targeted portion in the entire shape of the three-dimensional shaped object can be shown on the display section.

(9) The above aspect may be configured such that further comprising a step for acquiring, in the first shape data, second shape data that represents shapes of a plurality of portion regions separated from each other in the target region and a shape of a connection region that connects the portion regions, wherein the second acquisition step selects data of a portion corresponding to the second shape data from the first shaping data, and acquires second shaping data. According to this aspect, even in a case where a plurality of portion regions separated from each other are included in the target region, in the test shaping, it is possible to shape the three-dimensional shaped object in which the portion regions are appropriately connected to each other, and it is possible to improve the convenience of the user.

(10) The above aspect may be configured such that the second acquisition step acquires direction information that indicates a direction of the three-dimensional shape included in the target region and, based on the direction information, determines an arrangement direction of the target region in the second shaping data. According to the present aspect, the arrangement direction of the target region in the second shaping data can be determined simply.

(11) The above aspect may be configured such that the second acquisition step determines the arrangement direction so that the direction represented by the direction information is parallel to a surface direction of the stage and the direction information represents any of a surface direction of a plane section included in the target region, an axial direction of an axis section included in the target region, and a longitudinal direction of an elongated section included in the target region. According to this aspect, it is possible to shape the portion corresponding to the target region in a posture with a high probability of being able to appropriately shape the portion corresponding to the target region of the three-dimensional shaped object.

(12) According to a second aspect of the present disclosure, a data generation method for generating shaping data for producing a three-dimensional shaped object by discharging a shaping material from a discharge section toward a stage to stack layers is provided. This data generation method includes acquiring first shape data representing a three-dimensional shape of a three-dimensional shaped object and first shaping data that is generated based on the first shape data and that is for shaping the three-dimensional shaped object; displaying the three-dimensional shaped object on the display section based on the first shape data; determining a target region of the three-dimensional shaped object displayed on the display section based on a designation region that designates a range in a three-dimensional space; and selecting data of a portion corresponding to the target region from the first shaping data to generate second shaping data.

The present disclosure is not limited to the method for producing the three-dimensional shaped object and the data generation method described above, and can be realized by various aspects such as a three-dimensional shaping system, a three-dimensional shaping device, an information processing device, a computer program, and a non-transitory tangible recording medium in which a computer program is recorded in a computer-readable manner.

What is claimed is:

1. A method for producing a three-dimensional shaped object, the method comprising:
a first acquisition step for acquiring first shape data representing a three-dimensional shape of the three-dimensional shaped object and first shaping data that is generated based on the first shape data and that is for shaping the three-dimensional shaped object;
a first display step for displaying the three-dimensional shaped object on a display section based on the first shape data;
a determination step for determining a target region of the three-dimensional shaped object that was displayed on the display section based on a designation region that designates a range in three-dimensional space;
a second acquisition step for selecting data of a portion corresponding to the target region in the first shaping data and acquiring second shaping data; and
a shaping step, based on the second shaping data, for performing three-dimensional shaping to stack layers by discharging shaping material from a discharge section toward a stage.

2. The method for producing the three-dimensional shaped object according to claim 1, wherein
the first shape data includes at least one piece of information including at least one of accuracy information that indicates a required accuracy for each portion of the three-dimensional shaped object, stress information indicating stress for the each portion, temperature information that indicates a temperature change amount for the each portion, or fluid velocity information that indicates a fluid velocity of fluid for the each portion when the fluid is caused to flow in the three-dimensional shaped object.

3. The method for producing the three-dimensional shaped object according to claim 2, wherein
the determination step determines the designation region based on the at least the one piece of information.

4. The method for producing the three-dimensional shaped object according to claim 3, wherein
the first shape data includes the accuracy information and
the determination step determines, based on the accuracy information, the designation region so that the designation region includes a portion of the three-dimensional shaped object whose required accuracy is equal to or greater than a predetermined threshold value.

5. The method for producing the three-dimensional shaped object according to claim 3, wherein
the first shape data includes the stress information and
the determination step determines, based on the stress information, the designation region so that the designation region includes a portion of the three-dimensional shaped object whose stress is equal to or greater than a predetermined threshold value.

6. The method for producing the three-dimensional shaped object according to claim 3, wherein
the first shape data includes the temperature information and
the determination step determines, based on the temperature information, the designation region so that the designation region includes a portion of the three-dimensional shaped object whose temperature change amount is equal to or greater than a predetermined threshold value.

7. The method for producing the three-dimensional shaped object according to claim 3, wherein
the first shape data includes the fluid velocity information and
the determination step determines, based on the fluid velocity information, the target region so that the designation region includes a portion of the three-dimensional shaped object whose fluid velocity is equal to or greater than a predetermined threshold.

8. The method for producing the three-dimensional shaped object according to claim 1, further comprising:
a second display step for displaying, on the display section, a target portion corresponding to the target region of the three-dimensional shaped object and a non-targeted portion corresponding to a region of the three-dimensional shaped object different from the target region, wherein
the second display step displays the non-targeted portion in a simplified manner compared to the target portion.

9. The method for producing the three-dimensional shaped object according to claim 1, further comprising:
a step for acquiring, in the first shape data, second shape data that represents shapes of a plurality of portion regions separated from each other in the target region and a shape of a connection region that connects the portion regions, wherein
the second acquisition step selects data of a portion corresponding to the second shape data from the first shaping data and acquires second shaping data.

10. The method of producing the three-dimensional shaped object according to claim 1, wherein
the second acquisition step acquires direction information that indicates a direction of the three-dimensional shape included in the target region and, based on the direction information, determines an arrangement direction of the target region in the second shaping data.

11. The method for producing the three-dimensional shaped object according to claim 10, wherein
the second acquisition step determines the arrangement direction so that the direction represented by the direction information is parallel to a surface direction of the stage and
the direction information represents any one of a surface direction of a plane section included in the target region, an axial direction of an axis section included in the target region, or a longitudinal direction of an elongated section included in the target region.

12. A data generation method for generating shaping data for producing a three-dimensional shaped object by discharging a shaping material from a discharge section toward a stage to stack layers, the data generation method comprising:
acquiring first shape data representing a three-dimensional shape of a three-dimensional shaped object and first shaping data that is generated based on the first shape data and that is for shaping the three-dimensional shaped object;
displaying the three-dimensional shaped object on the display section based on the first shape data;
determining a target region of the three-dimensional shaped object displayed on the display section based on a designation region that designates a range in a three-dimensional space; and
selecting data of a portion corresponding to the target region from the first shaping data to generate second shaping data.
